(19) United States
(12) Patent Application Publication
(10) Pub. No.: US 2014/0080050 A1
(43) Pub. Date: Mar. 20, 2014

(54) TONER, DEVELOPMENT AGENT, IMAGE FORMING APPARATUS, AND IMAGE FORMING METHOD

(71) Applicants: Daisuke Asahina, Shizuoka (JP); Hiroshi Yamashita, Shizuoka (JP); Tsuyoshi Sugimoto, Shizuoka (JP); Taichi Nemoto, Shizuoka (JP); Yoshitaka Yamauchi, Shizuoka (JP); Satoyuki Sekiguchi, Shizuoka (JP); Susumu Chiba, Shizuoka (JP)

(72) Inventors: Daisuke Asahina, Shizuoka (JP); Hiroshi Yamashita, Shizuoka (JP); Tsuyoshi Sugimoto, Shizuoka (JP); Taichi Nemoto, Shizuoka (JP); Yoshitaka Yamauchi, Shizuoka (JP); Satoyuki Sekiguchi, Shizuoka (JP); Susumu Chiba, Shizuoka (JP)

(21) Appl. No.: 14/028,857

(22) Filed: Sep. 17, 2013

(30) Foreign Application Priority Data
Sep. 18, 2012 (JP) 2012-205046
Apr. 16, 2013 (JP) 2013-086126

(51) Int. Cl. G03G 9/087; G03G 13/22

(52) U.S. Cl. CPC G03G 9/08755; G03G 13/22
USPC 430/109.4; 430/124.1; 399/252

(57) ABSTRACT

Toner contains a binder resin, wherein the binder resin contains a block copolymer A containing a crystalline segment X and a non-crystalline segment Y, wherein the toner has a thermo-mechanical analysis (TMA) compressive deformation amount (TMA %) of 10% or less at 50° C. and a relative humidity of 90%, wherein the toner has a spin-spin relaxation time (t130) of 10 ms or greater at 130° C. as measured by pulse nuclear magnetic resonance (NMR), wherein the toner has a spin-spin relaxation time (t′70) of 1 ms or less at 70° C. as measured by pulse NMR when descending from 130° C. to 70° C.

### CROSS-REFERENCE TO RELATED APPLICATIONS

This patent application is based on and claims priority pursuant to 35 U.S.C. §119 to Japanese Patent Application Nos. 2012-205046 and 2013-086126 filed on Sep. 18, 2012 and Apr. 16, 2013, respectively, in the Japan Patent Office, the entire disclosures of which are hereby incorporated by reference herein.

### BACKGROUND

1. Technical Field

The present invention relates to toner and a development agent, an image forming apparatus, and an image forming method that use the toner.

2. Background Art

Technologies to fix toner derived from plant materials in an energy-efficient manner are in demand as a result of the popularity of eco-friendly products of late.

Typically, resins derived from plant materials are used for toner. For example, JP-H04-179967-A discloses using bidodegradable microbially-produced aliphatic polyesters as binder resins for toner. However, since these polyesters boost the softening temperature of toner, the fixing temperature thereof should be high, which is undesirable in terms of energy saving.

To lower the fixing temperature, for example JP-2597452-B1 (JP-H06-289644-A) discloses a method of adding a large amount of plant-derived wax to a naturally-derived resin. Although this method is successful in lowering the softening temperature of toner, the toner easily agglomerates because of the wax components, thereby degrading the productivity and the fluidity of the toner and resulting in degradation of toner transferability in a development device.

In addition, to secure low-temperature fixability and fixing stability, for example, JP-2006-91278-A and JP-2006-285150-A disclose methods of using a binder resin that contains two kinds of resins having different softening points and a naturally-derived resin.

In these methods, the resin having a lower softening point serves to link the resin having a higher softening point with the naturally-derived resin so that a biodegradable resin is uniformly dispersed in the binder resin.

However, if the naturally-derived resin accounts for a large ratio, the naturally-derived resin is not dispersed properly, which causes degradation of the developability of toner ascribable to variation in the charging power of the toner.

Consequently, the blending ratio of the naturally-designed resin in the binder resin is limited to around 20% by weight at the maximum, which is extremely low.

Furthermore, in any of the technologies and the methods described above, although they do not clearly mention, the glass transition temperature and the heat deformation temperature of toner lower by moisture absorption. As a consequence, when the toner is transferred or stored in a high temperature and high humidity environment, the toner particles or formed images stick together, meaning that usage of the toner is impractical.

As described above, using a naturally-derived resin as the main component of the binder resin of toner involves many drawbacks. Even when part of the binder resin is replaced with a naturally-derived resin, the blending ratio is limited. In view of this, it is desired to increase the ratio of the naturally-derived resin without a negative impact on the characteristics of the binder resin.

Moreover, to lower the fixing temperature of toner, the glass transition temperature of a toner binder is lowered in general. However, when the glass transition temperature of toner is simply lowered, the toner tends to agglomerate or clump. If agglomeration or clumping occurs in an image forming apparatus, it affects operations of the development device and can even cause the device to malfunction. If it does not go that far, when the toner may agglomerate or clump in a toner container, the toner may not be replenished, thereby decreasing the toner concentration, which results in production of defective images. For this reason, it is necessary to suppress this agglomeration or clumping. In addition, the storage stability of toner on the surface of a fixed image may also deteriorate. That is, since such a fixed image easily melts and is displaced, the images stick to other recording media placed thereon, which is not suitable for storage for a long period of time.

That is, the glass transition temperature is a designing point for a binder resin of toner. Therefore, it is not possible to obtain toner that secures good fixing by designing a fixing device having a lower fixing temperature when the glass transition temperature is simply lowered.

To strike a balance between the agglomeration resistance and the low-temperature fixability, an old method is known that uses a crystalline resin as the binder resin for toner.

However, due to shortage of the elasticity of the toner when melted, hot offset occurs. In addition, for example, JP-2009-053695-A and JP-2011-150229-A disclose toner having a core-shell structure prepared by a melting suspension method or an emulsification agglomeration method. However, to obtain toner having good agglomeration resistance without having a negative impact on low-temperature fixability, such toner still fails to meet the demand.

Furthermore, to solve this drawback, for example, JP-2011-123483-A discloses a method focusing on a crystalline resin. However, this method is vulnerable to conditions such as thermal history of manufacturing, storage, and fixing, and partial phase mixing). Therefore, the thus-obtained crystalline structure is unstable, thereby having adverse impacts on properties of toner, agglomeration resistance, image stability, etc.

### SUMMARY

The present invention provides improved toner that contains a binder resin, wherein the binder resin contains a block copolymer A comprising a crystalline segment X and a non-crystalline segment Y, wherein the toner has a thermo-mechanical analysis (TMA) compressive deformation amount (TMA %) of 10% or less at 50° C. and a relative humidity of 90%, wherein the toner has a spin-spin relaxation time (t130) of 10 ms or greater at 130° C. as measured by pulse nuclear magnetic resonance (NMR), wherein the toner has a spin-spin relaxation time (t′70) of 1 ms or less at 70° C. as measured by pulse NMR when descending from 130° C. to 70° C.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating an example of an image forming apparatus according to an embodiment of the present invention; and

FIG. 2 is a diagram illustrating an example of a process cartridge using the toner of the present disclosure.

### DETAILED DESCRIPTION

The present invention is to provide improved toner that overcomes trade-off between low temperature fixability and clumping resistance.

The present invention was made as a result of an investigation on resins using plant-derived materials to improve the fixability (low temperature fixability and offset resistance) made by the present inventors.

The present invention was:
1. Toner that contains a binder resin satisfies the following I to IV:
   I: the binder resin contains a block copolymer A containing a crystalline segment X and a non-crystalline segment Y,
   II: the toner has a thermo-mechanical analysis (TMA) compressive deformation amount (TMA %) of 10% or less at 50° C. and a relative humidity of 90%,
   III: the toner has a spin-spin relaxation time (t130) of 10 ms or greater at 130° C. as measured by pulse nuclear magnetic resonance (NMR), and
   IV: the toner has a spin-spin relaxation time (t′70) of 1 ms or less at 70° C. as measured by pulse NMR when descending from 130° C. to 70° C.

The present invention described above is described in detail and also embodiments of the following 2 to 10 are described.
2. The toner mentioned above, wherein the crystalline segment X is a polyester having a melting point of from 50° C. to 70° C. and is prepared by condensation of a polyol and a polycarboxylic acid.
3. The toner mentioned above, wherein the mass ratio of the crystalline segment X to the non-crystalline segment y is from 10/90 to 40/60.
4. The toner mentioned above, wherein the binder resin ccontains a crystalline polyester B and the mass ratio of the block copolymer A and the crystalline polyester B satisfies the following relation 1:

3≦[B/(A+B)]×100≦15 relation 1
5. The toner mentioned above, wherein the block copolymer A comprises a unit formed of a crystalline polyester A2 accounting for 20% by weight to 45% by weight therein and having a melting point of from 50° C. to 70° C.
6. The toner mentioned above, wherein the non-crystalline segment Y is a non-crystalline poly lactic acid segment and the mass ratio of L form to D form of the polylactic acid segment in the block copolymer A is from 70/30 to 90/10.
7. The toner mentioned above, wherein the block copolymer A contains a portion formed of a carbodimide compound accounting for 0.3% by weight to 3% by weight.
8. A development agent containing carrier and the toner mentioned above.
9. An image forming apparatus including a latent image bearing member; a charger to charge the surface of the latent image bearing member; an irradiator to irradiate the surface of the latent image bearing member to form a latent electrostatic image thereon; a development device to develop the latent electrostatic image with the toner mentioned above to form a visible image; a transfer device to transfer the visible image to a recording medium, and a fixing device to fix the visible image on the recording medium.
10. An image forming method including charging an image bearing member, irradiating the surface of the image bearing member to form a latent electrostatic image thereon, developing the latent electrostatic image with the toner mentioned above to obtain a visible toner image, transferring the visible toner image to a recording medium, fixing the visible toner image transferred to the recording medium; and cleaning the toner mentioned above remaining on the surface of the image bearing member.

Binder Resin

The toner for use in forming latent electrostatic images of the present disclosure contains a block copolymer A as an indispensable component of a binder resin and the block copolymer A is formed of a crystalline segment X and a non-crystalline segment Y. The block copolymer A has a particular higher-order structure represented by a microphase separation structure.

The block copolymer is made by combining different kinds of polymer chains with covalent binding. In general, such different kinds of polymer chains are non-compatible and not mixed like oil and water. In a simple mixture system, different polymer chains independently move, which causes macro phase separation. In a case of covalent binding, this macro phase separation does not occur because different kinds of polymer chains are bonded. Although the different kinds of polymer chains are bonded, the same kind of polymer chains tend to agglomerate and separate away from each other as far as possible so that portions having X in a large amount and portions having Y in a large amount are made alternatively depending on the size of the polymer chain. Therefore, by changing the phase mixing degree of the component X and the component Y, the composition, the length (molecular weight and distribution), and the ratio of X and Y, the form (structure) of the phase separation changes. For example, as described in A. K. Khandpur, S. Foster, and F. S. Bates, Macromolecules, 28 (1995) 8796-8806, periodic order meso structure such as Sphere structure, Cylinder structure, Gyroid structure, and Lamellar structure can be controlled.

In the present disclosure, since the block copolymer A is used, when crystallization is made from microphase separation structures, crystalline phases having several tens nm to several hundreds nm with the melted microphase separation structure as a model form can be regularly arranged if the periodic order meso structure can be controlled. Therefore, utilizing such a high-order structure, sufficient fluidity and deformity are secured based on the solid-liquid phase transfer phenomenon of crystalline portions in a case in which fixing and fluidity are required and in addition, the crystalline portions can be enclosed in the structure to diminish the mobility if fixing and fluidity are not required. As a result, the toner overcomes the trade-off between low temperature fixability and clumping resistance.

In addition, the high-order structure such as the molecule structure, the crystallinity, and the microphase separation structure of the block copolymer A are easily analyzed by conventional methods.

Specific examples thereof include, but are not limited ton, high resolution NMR measuring (1H, 13C, etc.), differential scanning calorimeter (DSC) measuring, wide angle X-ray diffraction measuring, (pyrolytic decomposition) Gas Chromatography/MassSpectrometry (GC/MS) measuring, Liquid Chromatography-Mass Spectrometry (LC/MS) measuring, infra-red absorption (IR) spectrum measuring, atom force microscope observation, and transmission electron microscope (TEM) observation.

There is no specific limit to the copolymerization method of the block copolymer A. Specific examples thereof include, but are not limited to, the following 1 to 3. In terms of the freedom of molecule designing, 3 is preferable in particular. In addition, lactide ring-opening method is preferable in terms of productivity. Furthermore, a supercritical method disclosed in JP-2012-059755-A can be also used. This is preferable in terms of hydrolysis resistance and productivity because the amount of remaining monomers is less.
1. A copolymerization method including: dissolving or dispersing a non-crystalline resin preliminarily prepared by polymerization reaction and a crystalline resin preliminarily prepared by polymerization reaction in a suitable solvent and conducting reaction between the solution or liquid dispersion with an elongating agent having at least two functional groups reactive with hydroxyl groups such as isocyante groups, epoxy groups, carbodiimide groups or carboxylic groups located at polymer terminals.
2. A method including melt-kneading a non-crystalline resin preliminarily prepared by polymerization reaction and a crystalline resin preliminarily prepared by polymerization reaction followed by conducting ester change reaction under a reduced pressure.
3. A copolymerization method including: ring-opening polymerizing non-crystalline resins from polymer chain terminals of a crystalline resin preliminarily prepared by polymerization reaction while using the hydroxyl group of the crystalline resin as a polymerization initiating component.

In the copolymerization of the block copolymer A, the mass ratio of the non-crystalline resin to the crystalline resin is preferably from 1.5 to 4.0. When the ratio is too small, the crystalline portion tends to have an excessively large impact, thereby breaking the particular microphase separation structure of the block copolymer, resulting in total formation of lamellar structure. This has a positive impact in a process such as fixing requiring fluidity, but an adverse impact in the case in which fluidity and deformity are not required, for example, during storage or in the transfer process after fixing in a machine because the mobility is not diminished. To the contrary, when he ratio is too large, the non-cryrtalline portion tends to have an excessively large impact. This has a positive impact in the case in which fluidity and deformity are not required, for example, during storage or in the transfer process after fixing in a machine but does not sufficiently secure fluidity and deformity in a process such as fixing requiring fluidity.

Known elongating agents can be suitably used. One or more kinds of such known elongating agents can be used depending on the particular application. In particular, isocyanate compounds are preferable in terms of cost and reactivity. Toluene diisocyanate (TDI), methylenediphenyldiisocyanate (MDI), hexamethylene diisocyanate (HDI), hydrogenerated methylenediphenyldiisocyanate (MDI), and isophorone diisocyanate (IPDI) are partiularly preferable.

With regard to the content of the elongating agent in the copolymerization, the ratio (OH/NCO) of the total mol number of polyester polyol to the total mol number of isocyanate is preferably from 0.35 to 0.7. When the ratio (OH/NCO) is too small, the joinder of the non-crystalline resin and the crystalline resin is not sufficient. Therefore, these tend to be independently present, thereby unable to secure the stability of the quality, which is not preferable. In addition, when the ratio (OH/NCO) is too large, the molecular weight of the copolymerization unit and the interaction between urethane groups tends to be excessively strong. Therefore, fluidity and deformity are not secured in a process such as fixing requiring fluidity, which is not preferable.

As the thermal characteristics, the toner of the present disclosure has a thermo-mechanical analysis (TMA) compressive deformation amount (TMA %) of 10% or less and preferably 7% or less at 50° C. and a relative humidity of 90%.

When the TMA (%) is too large, the toner is easily deformed when transferred in summer or on the sea. As a consequence, the storage under dynamic conditions including error factors are inferior if the static storage or storage under dry conditions secured by penetrating tests, etc. is excellent. That is, the agglomeration resistance deteriorates and if toner is transferred in summer or stored in warehouse and considering the temperature in a machine can be high, toner particles easily agglomerate, thereby degrading the transferability and conveyance property, resulting in production of defective images.

In the present disclosure is, by chemically bonding a crystalline segment X and a non-crystalline segment Y and controlling the structures of each segment, the molecular movement of the crystalline segment X is diminished.

Pulse NMR is suitable to scale the molecular movement. Unlike high resolution NMR, pulse NMR does not provide chemical shift data (local chemical structure) but can quickly measure the spin-lattice relaxation time (T1) and the spin-spin relaxation time (T2) of 1H nuclear having a close relation with the molecular movability. Specific examples of the measuring methods based on pulse NMR include, but are not limited to, Hahn echo method, solid echo method, Carr Purcell Meiboom Gill method, and 90-degree pulse method. Since the toner of the present disclosure and the resin for use in the toner have a medium spin-spin relaxation time (T2), Hahn echo method is most suitable.

In the present disclosure, the spin-spin relaxation time (t130) at 130° C. is used as the scale of the molecular movement during fixing and the spin-spin relaxation time (t′70) when the temperature descends from 130° C. to 70° C. is used as the scale of the molecular movement relating to friction resistance during image transfer in a machine.

That is, it indicates that the toner has sufficient mobility in a process such as fixing requiring fluidity and the mobility is sufficiently diminished when fluidity is not required.

The value of t130 is 10 ms or greater. When value of t130 is less than 10 ms, th fluidity and the deformity of the toner and the resins tend to deteriorate because the molecular movement is insufficient when heated. As a result, image flattening property deteriorates and adhesion of the toner and a material on which an image is printed is worsened, thereby degrading the image quality regarding gloss, peeling-off of images, etc. In addition, a high value of t130 indicates that sufficient molecular movement is secured in a fixing temperature range, whichi s good for flattening property, gloss, etc. Therefore, there is no specific upper limit to the value of t130.

Furthermore, the value of t′70 is 1 ms or less. When the value of t′70 is too large, the image contacts and is frictioned with rollers and transfer members located in the discharging process after fixing before the molecular movement is diminished, which results in marks or gloss change on the surface of the image. In addition, since it is preferable that the molecular movement during cooling down the image is diminished as quickly as possible after fixing in terms of friction resistance, there is no specific lower limit to t′70.

With regard to the polyesters forming the crystalline segment X, polyesters having a melting point of from 50° C. to 70° C. prepared by condensing an aliphatic dihydric alcohol and an aliphatic dicarboxylic acid are preferable and the mass ratio (X/Y) of the crystalline segment X to the non-crystalline segment Y is preferably from 10/90 to 40/60. When the melting point is 50° C. or higher, the high temperature stability of toner does not deteriorate because of the low temperature melting property of the crystalline segment X. When the melting point is 70° C. or lower, the low temperature fixability of the toner does not deteriorate because of insufficient melting property upon application of heating during fixing of the crystalline segment X. In addition, when X/Y is inside the range mentioned above, none of the crystalline segment X and the noncrystalline segment Y have excessively large impacts. Therefore, the toner is free from the problem described in the mass ratio of the non-crystalline resin and the crystalline resin.

The weight average molecular weight Mw of the block copolymer A is preferably from 20,000 to 70,000. When the weight average molecular weight Mw is too small, the fluidity during fixing is excellent but the molecualr weight is too small as the system. As a consequence, the viscoelasticity becomes insufficient, thereby easily causing offset and degradation of storage and friction resistance, which is not preferable.

When the weight average molecular weight Mw is too large, the fluidity tends to become particularly worse, which prevents good low temperature fixability. This is not preferable.

In the present disclosure, it is preferable to contain the block copolymer A and the crystalline polyester B as the binder resin. Whether the polyester is crystalline or not can be confirmed by evaluation on the melting point obtained by differential scanning calorimetry (DSC) measuring and the relative crystallinity by wide angle X-ray diffraction.

The content ratio [B/(A+B)]×100 of the crystalline polyester B is preferably less than 20% and more preferably from 3% by weight to 15% by weight. Because of this, the toner does not melt in a storage environment or in a development device. As a result, the viscosity sharply drops as the phase changes in a predetermined temperature range so that the low temperature fixability and the agglomeration resistance of the toner overcome trade-off. In particular, when the content ratio is from 3% by weight to 15% by weight, the low temperature fixability securely exhibits, which leads to sufficient agglomeration resistance.

Since the crystalline polyester B is crystalline, it exhibits sharp heat-melting property around the fixing initiation temperature. By using the crystalline polyester Bhaving such properties with the block copolymer A, agglomeration resistance is maintained until immediately before melting starts and the viscosity sharply drops by melting of the crystalline polyester B at the melting initiation temperature, which starts melting and deformation of the toner to fill the gaps between the binder resins doformed by heating and compression. Consequently, toner having both excellentagglomeration resistance and low temperature fixability is obtained.

It is preferable to scatter dispersion elements of the microparticulated crystalline polyester B in the block copolymer A instead of simply blending the polyester B in the copolymer A. If both are simply blended, the polyester B tends to be unevenly dispersed in copolymer A so that the quality becomes unstable. Furthermore, in some cases, the agglomeration resistance deteriorates or the polyester B does not sufficiently serve as a trigger to demonstrate low temperature fixing. Fine-dispersion can be conducted by, for example, a method including crystallizing the polyester B described in JP-2012-108462-A and thereafter forming a liquid dispersion out of the resultant by a bead mill, etc. The dispersion particle diameter of the toner is preferably 1 μm or less and in particular the ratio of particles having a dispersion particle diameter greater than 1 μm is preferably 15% or less and more preferably 10% or less. When coarse particles accounts for a large ratio, it is significantly the same as when the polyester B is unevenly dispersed in the toner. This is not preferable in terms of quality and stable production.

The crystalline polyester for use in the block copolymer A and the crystalline polyester B are obtained by reacting a polyol component with a polybasic carboxylic acid component such as a polybasic carboxylic acid, a polybasic carboxylic acid anhidride, and polyhydric carboxylic esters. In the present disclosure, the crystalline polyester B excludes modified polyester resins.

Polyol Component

There is no specific limit to the polyol component. For example, diols and alcohols having three or more hydroxyl groups are suitable.

Specific examples of diols include, but are not limited to, saturated aliphatic diols. The saturated aliphatic diol includes linear saturated aliphatic diols and branch type saturated aliphatic diols. Linear saturated aliphatic diols are preferable, in particular linear saturated aliphatic diols having 4 to 12 carbon atoms. Branch type saturated aliphatic diols decrease the crystallinity of the crystalline polyester B, thereby lowering the melting point thereof. In addition, when the number of carbon atoms in the main chain is too small, the melting point tends to become high in the case of polycondensation with an aromatic dicarboxylic acid, which makes the low temperature fixing difficult. When the number of carbon atoms is too large, materials are not easily available. The number of the carbon atoms in the main chain is preferably 12 or less.

Specific examples of the saturated aliphatic diols include, but are not limited to, ethylene glycol, 1,3-propane diol, 1,4-butane diol, 1,5-pentane diol, 1,6-hexane diol, 1,7 heptane diol, 1,8-octane diol, 1,9-nonane diol, 1,10-decane diol, 1,11-undecane diol, 1,12-dodecane diol, 1,13-tridecane diol, 1,14-tetradecane diol, 1,18-octadecane diol, and 1,14-eicosane decane diol. Among these, in terms that the crystalline polyester B has a high crystallinity and an excellent sharp melting property, 1,4-butane diol, 1,6-hexane diol, 1,8-octane diol, 1,10-decane diol, and 1,12-dodecane diol are preferable.

Specific examples of the alcohols having three or more hydroxyl groups include, but are not limited to, glycerin, trimethylol ethane, trimethylol propane, and pentaerythritol.

These can be used alone or in combination.

Polybasic Carboxylic Acid Component

There is no specific limit to the polybasic carboxylic acid. For example, dibasic carboxylic acids and tribasic or higher basic carboxylic acids are suitable. The number of carbon atoms is preferably from 4 to 12.

Specific examples of dicarboxylic acids include, but are not limited to, saturated aliphatic dicarboxylic acids such as oxalic acid, succinic acid, glutaric acid, adipic acid, acid, azelaic acid, sebacic acid, 1,9-nonane dicarboxylic acid, 1,10-decane dicarboxylic acid, 1,12-dodecane dicarboxylic acid, 1,14-tetradecane dicarboxylic acid, and 1,18-octadecane dicarboxylic acid; dibasic aromatic carboxylic acids such as phthalic acid, isophthalic acid, terephthalic acid, naphthalene-2,6-dicarboxylic acid, malonic acid, and mesaconic acid; and anhydrides or lower alkylesters thereof.

Specific examples of the tribasic or higher basic carboxylic acids include, but are not limited to, 1,2,4-benzene tricarboxylic acid, 1,2,5-benzene tricarboxylic acid, 1,2,4-naphtalene tricarboxylic acid, and their anhydrides or lower alkyl esters.

In addition to the above-specified saturated aliphatic dicarboxylic acids and the aromatic dicarboxylic acids, the polybasic carboxylic acid component includes a diacarboxylic acid component having a sulfonic acid group. In addition to the above-specified saturated aliphatic dicarboxylic acids and the aromatic dicarboxylic acids, diacarboxylic acid components having carbon-carbon double bond can be suitably contained.

These can be used alone or in combination.

The block copolymer A contains a unit formed of a crystalline polyester A2 having a melting point of 50° C. or higher and preferably from 50° C. to 70° C. in an amount of from 15% by weight to 50% by weight. Preferably, it is from 20% by weight to 45% by weight.

Since the crystalline polyester demonstrates phase transfer at the melting point and the viscosity thereof drasically decreases, the toner agglomerate if stored at the melting point or higher. For this reason, a crystalline polyester having a melting point of 50° C. or higher, which is sufficiently higher than the temperature during storage or in use. However, when the melting point is too high, the low temperature fixability tends to deteriorate. The melting point can be obtained as the melting peak temperature of input compensation differential scanning calorimetry measuring specified in JIS K-7121. Some crystalline resins multiple melting peaks, in which case the maximum peak is regarded as the melting point.

In addition, when the content of the unit formed of the crystalline polyester A2 is from 15% by weight to 50% by weight and preferably from 20% by weight to 45% by weight, the toner does not melt in an environment where the toner is stored or by stirring in a development device. Therefore, since the viscoelasticity sharply drops in a predetermined temperature range, the low temperature fixability and the agglomeration resistance overcome trade-off. When the content ratio is low (e.g., 15% by weight), the polylactic acid portion is dominant and thus the toner has a high viscosity. Therefore, the low temperature fixability does not exhibit, thereby degrading the image quality. To the contrary, when the content ratio is high (e.g., 50% by weight), the fluidity of the toner is excellent at low temperatures but the viscosity during fixing (i.e., cooling-down and solidifying) is insufficient, thereby easily causing offset. As a consequence, the fixing temperature range is extremely narrow. In addition, agglomeration resistance is low so that toner easily agglomerates in an image forming apparatus.

The main resin being the block copolymer A with the copolymerization mentioned above can be confirmed by evaluation of the melting point measured by DSC, the relative crystallinity by wide angle X-ray diffraction, and the domain form or the size of the microphase separation structure observed by an atom force microscope or TEM. For example, in the area in which the unit formed of the crystalline polyester A2 is less than 15% by weight, the polylactiv acid portion is dominant so that is not possible to observe a clear phase separation structure. In the area in which the unit formed of the crystalline polyester A2 is greater than 50% by weight, the crystalline polyester portion is dominant, thereby causing total area lamella accompanying domain breakage.

The ratio of L-form to D-form of the polylactic acid portion in the block copolymer A is preferably from 70/30 to 90/10. That is, the polylactic acid portion is preferably non-crystalline. When the L-form to D-form ratio is 90/10 or lower, the polylactic acid portion has an increased crystallinity, thereby not degrading the low temperature fixability. As a result, a suitable fixing temperature range is obtained. In addition, workability or productivity is not degraded or the cost increase is avoided. If the L-form to D-form ratio surpasses 70/30, handling is not made difficult by thermal expansion and in addition, the cost does not increase because D-form accounting for a smaller ratio is not used in a large quantity. In addition, the racemic level of the polylactic acid portion is basically stock-guaranteed but can be confirmed by a known method such as pyrolysis GC/MS connected to chiral column.

The crystalline polyester B preferably contains a structure unit derived from a saturated aliphatic dicarboxylic acid having 4 to 12 carbon atoms and a structure unit derived from a saturated aliphatic diol having 2 to 12 carbon atoms in terms that excellent low temperature fixability is demonstrated.

There is no specific limit to the melting point of the crystalline polyester B. The melting point is preferably from 50° C. to 80° C. When the melting point is too low, the crystalline polyester B easily melts at low temperatures, thereby degrading the agglomeration resistance of toner. When the melting point is too high, the crystalline polyester B tends to be not melted sufficiently upon application of heat during fixing, thereby degrading the low temperature fixability.

The melting point can be measured by the endothermic peak value from the DSC chart obtained in the differential scanning calorimeter (DSC) measuring.

Furthermore, the block copolymer A preferably has a portion formed of a carbodiimide compound in an amount of from 0.3% by weight to 3% by weight. This is a point to reduce the hydrolysis property of the polylactic acid portion. When the portion accounts for too small ratio, e.g., less than 0.3% by weight, the enclosure of the carboxylic group and hydroxyl group produced by the initial acid value decrease and decomposition does not exhibit. When the portion accounts for too large ratio, e.g., greater than 3% by weight, it tends to become an excessive amount and invite cost increase.

The block copolymer A is optionally subject to terminal closure or elongation by an isocyanate compound, an epoxy compound, etc. unless the present disclosure is preserved. Isocyanate compounds are preferable in terms of cost and reactivity.

Specific examples of isocyaante components include, but are not limited to, aromatic diisocyanates having 6 to 20 carbon atoms, aliphatic diisocyanates having 2 to 18 carbon atoms, alicyclic diisocyanates having 4 to 15 carbon atoms, aromatic aliphatic diisocyanates having 8 to 15 carbon atoms, modified diisocyanates thereof (modified by a urethane group, a cabodiimide group, an allophanate group, a urea group, a biuret group, a uretdione group, a uretimine group, an isocyanulate group, and an oxazoline group), in which the number of carbon atoms excludes the number of carbon atoms in NCO groups). These can be used alone or in combination. Optionally, tri- or higher isocynates can be used in combination therewith.

Coloring Agent

Any known dye or pigment can be used as the coloring agent for use in the toner of the present disclosure. Specific examples thereof include, but are not limited to, carbon black, iron black, Sudan Black SM, Benzidine Yellow, Solvent Yellow (21, 77, 114), Pigment Yellow (12, 14, 17, 83), Indofast Orange, Irgazin Red, Paranitroaniline Red, Toluidine Red, Solvent Red (17, 49, 428, 5, 13, 22, 48 • 2, etc.), Dipserse Red, Carmine FB, Pigment Orange R, Lake Red 2G Rohdamine FB, Rohdamine B Lake, Methylviolet B Lake, Phthalocyanine Blue, Solvent Blue (25, 94, 60, 15 • 3, etc.), Pigment Blue, Brilliant Green, Phthalocyanine Green, Oil Yellow GG, Kayasett YG, Orasol (tm) Brown B, and Oil Pink OP. These can be used alone or as a mixture of two or more.

Moreover, it is possible to add magnetic powder (such as powder of ferromagnetic metal such as iron, cobalt, and nickel or compounds of magnetite, hematite, and ferrite) as a material serving as a coloring agent.

The content of the coloring agent is preferably from 0.1 parts by weight to 40 parts by weight and furthermore preferably from 0.5 parts by weight to 10 parts by weight based on 100 parts by weight. In addition, when using magnetic powder, the content is preferably from 20 parts by weight to 150 parts by weight and furthermore preferably from 40 parts by weight to 120 parts by weight.

Releasing Agent

The releasing agent for use in the toner of the present disclosure preferably has a softening point of from 50° C. to 170° C. Specific examples thereof include, but are not limited to, polyolefine wax, natural wax such as carnauba wax, paraffin wax and rice wax), aliphatic alcohol (such as triacontanol) having 30 to 50 carbon atoms, and aliphatic acids (such as triacontane carboxylic acid) having 30 to 50 carbon atoms.

Specific examples of polyolefin wax include, but are not limited to, (co)polymers (including heat degradation type) of olefins (such as ethylene, propylene, 1-butene, isobutylenen, 1-hexene, 1-dodecene, 1-octadecene, and mixturtes thereof); oxygen-causing and/or ozone-causing oxides of (co)polymers of olefins; maleic acid-modified of (co)polymers of olefins (such as compounds modified by malecic acid or derivatives thereof (such as maleic acid anhydride, monomethyl maleate, monobutyl maleate, and dimethyl maleate); copolymers of olefins, unsaturated carboxylic acids [such as (meth)acrylic acid, itaconic acid, and maleic acid anhydride], and/or unsaturated carboxylic acid alkyl esters [such as (meth)acrylic acid alkyl (having 1 to 18 carbona toms) esters and maleic acid alkyl (having 1 to 18 carbona toms) esters]; polymethylene (such as Fischer-Tropsch wax such as sazol wax); aliphatic acid metal salts (such as calcium stearate); and aliphatic acid esters (such as behenic acid behenyl).

The toner of the present disclosure optionally contains additives such as charge control agents, fluidizers, fluidity improvers, cleaning property improvers, and magnetic materials.

Specific examples of charge control agents include, but are not limited to, nigrosine dyes, triphenylmethane dyes having a tertiary amine in its side chain, quaternary ammonium salts, polyamine resins, imidazole derivatives, polymers having quaternary ammonium salt groups, metal-containing azo dyes, copper phthalocyanine dyes, metal salts of salicylic acid, boron complex of benzil acid, polymers having sulfonic acid group, fluorine-containing polymers, polymers having a halogen-substituted aromatic ring, metal complexes of alkyl detivatives of salicylic acid, and cetyltrimethylammonium bromide.

Specific examples of such ifluidizer include, but are not limited to, colloidal silica, alumina powder, titanium oxide powder, calcium carbonate powder, barium titanate, magnesium titanate, calcium titanate, strontium titanate, zinc oxide, quartz sand, clay, mica, sand-lime, diatom earth, chromium oxide, cerium oxide, red iron oxide, antimony trioxide, magnesium oxide, zirconium oxide, barium sulfate, and barium carbonate.

Specific examples of such fluidity improver include, but are not limited to, silane coupling agents, silylatng agents, silane coupling agents containing an alkyl fluoride group, organic titanate coupling agents, aluminum containing coupling agents, silicone oil, and modified silicone oil.

Specific examples of such cleaning property improvers include, but are not limited to, zinc stearate, calcium stearate, aliphatic metal salts of stearic acid, and resin particles prepared by a soap-free emulsion polymerization method such as polymethyl methacrylate particulates and polystyrene particulates. The resin particles preferably have a relatively narrow particle size distribution and the volume average particle diameter thereof is preferably from 0.01 μm to 1 μm.

Specific examples of such magnetic material include, but are not limited to iron powder, magnetite, and ferrite. Among these, white magnetic materials are preferable in terms of color tone.

The composition ratio (% by weight) of each component in the toner based on 100% by weight of toner is: the binder resin is preferably from 30% by weight to 97% by weight, more preferably from 40% by weight to 95% by weight, and furthermore preferably from 45% by weight to 92% by weight; the coloring agent is preferably from 0.05% by weight to 60% by weight, more preferably from 0.1% by weight to 55% by weight, and furthermore preferably from 0.5% by weight to 50% by weight; the releasing agent is preferably from 0.1% by weight to 30% by weight, more preferably from 0.5% by weight to 20% by weight, and furthermore preferably from 1% by weight to 10% by weight; the charge control agent is preferably from 0% by weight to 20% by weight, more preferably from 0.1% by weight to 10% by weight, and furthermore preferably from 0.5% by weight to 7.5% by weight; and the fluidizer is preferably from 0% by weight to 10% by weight, more preferably from 0% by weight to 5% by weight, and furthermore preferably from 0.1% by weight to 4% by weight.

The total content of the additives is preferably from 3% by weight to 70% by weight, more preferably from 4% by weight to 58% by weight, and furthermore preferably from 5% by weight to 50% by weight.

When the composition ratio is within the range specified above, toner having an excellent chargeability is easily obtained.

In addition, the volume average particle diameter of the toner is preferably from 3 μm to 15 μm.

Method of Manufacturing Toner

The toner of the present disclosure is prepared by a known method such as a mixing, kneading, and pulverization method, an emulsification phase transfer method, polymerization method, etc. For example, if a mixing, kneading, and pulverization method is employed, toner is made by: dryly blending the compositions excluding a fluidizer of toner; melt-kneading the blended material followed by coarse-pulverization; micropaticulating the resultant by a jet mill pulverizer, etc.; subsequent to classification to obtain particulates having a volume average particle diameter 8D50) of from about 5 μm to 20 μm, adding a fluidizer to the resultant. The volume average particle diameter (D50) is measurable by Coulter Counter (e.g., Multisizer III, manufactured by Beckman Coulter Inc.).

When preparing toner by an emulsification phase transfer method, the compositions of the toner excluding a fluidizer are dissolved or dispersed in an organic solvent and thereafter water is added for emulsification followed by separation and classification. In addition, it is possible to employ a method using organic particulates described in JP-2002-284881-A.

With regard to the manufacturing method of toner, a method including forming mother toner particles is described in detail.

Preparation of Aqueous Medium (Aqueous Phase)

The aqueous medium is prepared by, for example, dispersing resin particles in an aqueous medium. There is no specific limit to the addition amount of the resin paricles in the aqueous medium. The content thereof is preferably from 0.5% by weight to 10% by weight.

There is no specific limit to the aqueous medium. Specific examples thereof includes, but are not limited to, water, a solvent mixable with water, and a mixture thereof. These can be used alone or in combination. Water is particularly preferable.

There is no specific limit to the solvent mixable with water. Specific examples thereof include, but are not limited to, alcohols, dimethylformamide, tetrahydrofuran, cellosolves, and lower ketones. There is no specific limit to such alcohols. Specific examples thereof include, but are not limited to, methanol, isopropanol, and ethylene glycol. There is no specific limit to such lower ketones. Specific examples of the lower ketones include, but are not limited to, acetone and methyl ethyl ketone.

Preparation of Oil Phase

The oil phase is prepared by dissolving or dispersing in an organic solvent toner materials containing the block copolymer A, the crystalline polyester B, a releasing agent, and a coloring agent.

There is no specific limit to the selection of the organic solvent and any solvent that can dissolve or disperse the toner material is suitably selected. For example, a volatile solvent having a boiling point of 150° C. or lower is preferable because it can be removed easily.

There is no specific limit to the selection of the solvent having a boiling point of 150° C. or lower. Specific examples of such solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, etc. These can be used alone or in combination.

Toluene, xylene, benzene, methylene chloride, 1,2-dichloroethane, chloroform, and carbon tetrachloride are preferable and ethyl acetate is particularly preferable.

Emulsification or Dispersion

Emulsification or dispersion of is conducted by dispersing an oil phase containing the toner material in the aqueous medium. There is no specific limit to the method of stabily forming a liquid dispersion. For example, a method is employed which includes adding an oil phase prepared by dissolving or dispersing a toner material in a solvent to an aqueous medium followed by dispersion by a shearing force.

There is no specific limit to a dispersing device for the dispersion. Specific examples thereof include, but are not limited to, a low speed shearing type dispersing device, a high speed shearing type dispersing device, a friction type dispersing device, a high-pressure type dispersing device, and an ultrasonic dispersing device. Among these, high speed shearing type dispersing devices are preferable because they can control the particle diameter of dispersion element, i.e., oil droplet, in a range of from 2 μm to 20 μm.

When a high speed shearing type dispersion device is used, conditions such as the number of rotation, the dispersion time, and the dispersion temperature are selected depending on a particular application.

There is no specific limit to the number of rotation. A range of from 1,000 rotation per minute (rpm) to 30,000 rpm is preferable and, 5,000 rpm to 2,000 rpm, more preferable.

There is no specific limit to the dispersion time. The dispersion time is preferably from 0.1 minutes to 5 minutes in a case of a batch system.

There is no specific limit to the dispersion temperature. The dispersion temperature is preferably from 0° C. to 150° C. under pressure.

There is no specific limit to the content of the aqueous medium when emulsifying or dispersing a toner material. The content is preferably from 50 parts by weight to 2,000 parts by weight and more preferably from 100 parts by weight to 1,000 parts by weight.

A content that is too small tends to cause deterioration of the dispersion status of a toner material and the resultant mother toner particle may not have a desired particle diameter. A content that is too large easily results in an increase in the production cost.

When emulsifying or dispersing an oil phase containing a toner material, it is preferable to use a dispersing agent to stabilize the dispersion element such as oil droplets, and obtain a desired form with a sharp particle size distribution.

There is no specific limit to the dispersion agent and any known dispersion agent can be suitably used. Specific examples thereof include, but are not limited to, surface active agents, inorganic compound dispersion agents not or little soluble in water, and polymeric protective colloids. These can be used alone or in combination.

Among these, surface active agents are preferred.

Specific examples of such surface active agents include, but are not limited to, anionic surface active agents, cationic surface active agents, non-ionic active agents, and ampholytic surface active agents.

There is no specific limit to the anionic surface active agent. Specific examples thereof include, but are not limited to, alkylbenzene sulfonic acid salts, α-olefin sulfonic acid salts, and phosphoric acid salts.

Removal of Organic Solvent

There is no specific limit to removing the organic solvent from the liquid dispersion such as the emulsified slurry. The organic solvent is removed by, for example, a method of evaporating the organic solvent in oil droplets by gradually heating the entire reaction system or a method of spraying a liquid dispersion in dried atmosphere to remove the organic solvent in oil droplets.

Mother toner particles are formed when the organic solvent is removed. The mother toner particles can be washed and dried followed by optional classification. For example, the mother toner particles can be classified by removing fine particles by a cyclone, a decanter, a centrifugal, etc., or it is possible to dry the mother toner particles before classification.

The mother toner particles can be mixed with particles such as external additives or charge control agents. Particles of external additives, etc. can be prevented from detaching from the surface of the mother toner particles by applying a mechanical impact.

There is no specific limit to the method of applying a mechanical impact. Specific examples thereof include, but are not limited to, methods in which an impact is applied to a mixture by using a blade rotating at a high speed, a method in which a mixture is put into a jet air to collide particles against each other or into a collision plate.

There is no specific limit to mechanical impact applicators employed in such methods. Specific examples thereof include, but are not limited to, ONG MILL (manufactured by Hosokawa Micron Co., Ltd.), modified I TYPE MILL (manufactured by Nippon Pneumatic Mfg. Co., Ltd.) in which the pressure of air used for pulverizing is reduced, HYBRIDIZATION SYSTEM (manufactured by Nara Machine Co., Ltd.), KRYPTRON SYSTEM (manufactured by Kawasaki Heavy Industries, Ltd.), automatic mortars, etc.

Development Agent

The development agent of the present disclosure contains at least the toner and other optional components such as toner carrier (hereinafter referred to carrier).

Using such a development agent, transfer property and chargeability become excellent, which leads to stable production of quality images. The development agent can be a one-component development agent and a two-component development agent. The two-component development agent is preferable in terms of working life thereof particularly when used in a high speed printer that meets the demand of high speed information processing speed of late.

When a one-component development agent is used and replenished a number of times, the variation of the particle diameter of the toner is small and filming of the toner on the developing roller and fusion bonding of the toner onto members such as a blade for regulating the thickness of a toner layer never or little occurs. Therefore, good and stable developability is sustained even when the development agent is stirred in a development device for an extended period of time, which secures stable production of quality images.

When a two-component development agent is used and replenished a number of times, the variation of the particle diameter of the toner is small. In addition, good and stable developability is sustained even when the development agent is stirred in a development device for an extended period of time, which secures stable production of quality images.

When a two-component development agent is used, the toner of the present disclosure is mixed with carrier. There is no specific limit to the content of the carrier. It is preferably from 90% by weight to 98% by weight and more preferably from 93% by weight to 97% by weight.

Carrier

There is no specific limit to the carrier. Carrier is preferable which contains a core material and a resin layer that covers the core material.

Core Material

There is no specific limit to the material for the core material. The material for the core material can be selected depending on a particular application. Specific examples thereof include, but are not limited to, manganese-strontium based material having 50 emu/g to 90 emu/g or manganese-magnesium based material having 50 emu/g to 90 emu/g. To secure the density of images, high magnetized materials, for example, using iron powder with not less than 100 emu/g and magnetite having 75 emu/g to 120 emu/g, is preferable. Low magnetized materials such as copper-zinc based material having 30 emu/g to 80 emu/g are preferable because it can reduce an impact of the development agent in a filament state on an image bearing member, which is advantageous to output quality images.

These can be used alone or in combination.

There is no specific limit to the volume average particle diameter of the core material. The volume average particle diameter thereof preferably ranges from 10 pin to 150 μm and more preferably from 40 μm to 100 μm. When the volume average particle diameter is too small, the ratio of fine particles in carriers tends to increase and the magnetization per particle tends to decrease, which may lead to scattering of the carrier. When the volume average particle diameter is too large, the specific surface area tends to decrease, which may cause scattering of toner. Thus, the representation of the solid portion may deteriorate particularly in a case of a full color image having a large solid portion.

### Cover Layer

The cover layer has at least a binder resin and optionally other components such as inorganic particulates.

There is no specific limit to the binder resin and any known binder resin can be suitably used.

Specific examples of the binder resins include, but are not limited to, polyolefins (such as polyethylene and polyolefin) and modified compounds thereof; cross-linkable copolymerized compounds containing styrene, acrylic resins, acrylonitrile, vinyl acetate, vinyl alcohol, vinyl chloride, vinyl carbazole, and vinyl ether; silicone resins formed of organo siloxane bonding or modified compounds thereof (such as alkyd resins, polyester resins, epoxy resins, polyurethane resins, and polyimides resins); polyamides; polyester, polyurethane, polycarbonate, urea resins, melamine resins, benzoguanamine resins, epoxy resins, ionomer resins, polyimides resins, and derivatives thereof.

These materials can be used alone or in combination. Among these, siilcone resins are particularly preferable.

There is no specific limit to the silicone resins and any known silicone resins are suitably used. Specific examples thereof include, but are not limited to, straight silicone resins; and silicone resins modified by alkyd resins, polyester resins, epoxy resins, acrylic resins, urethane resins, etc.

It is possible to use silicon resins alone or together with a cross-linkable component, a charge size control component, etc. A specific example of the cross-linkable component is a silane coupling agent. Specific examples of the silane coupling agents include, but are not limited to, methyl trimethoxy silane, methyl triethoxy silane, octyl trimethoxy silane, and amino silane coupling agents.

The cover layer optionally contains particulates. There is no specific limitation to such particulates and any known material can be suitably used. Specific examples thereof include, but are not limited to, inorganic particulates such as metal powder, tin oxide, zinc oxide, alumina, potassium titanate, barium titanate, and aluminum borate; electroconductive polymer such as polyaniline, polyacetylaene, polyparaphenylene, poly(para-phenyl sulfide), polypyrrole, and parylene; and organic particulates such as carbon black.

The surface of the particulates may be electroconductive treated. A specific method of such electroconductive treatment is: covering the surface of the particulate with a form of solid solution or fusion of aluminum, zinc, copper, nickel, silver, or alloyed metal thereof; zinc oxide, titanium oxide, tin oxide, antimony oxide, indium oxide, bismuth oxide, indium oxide in which tin is doped, tin oxide in which antimony is doped, or zirconium oxide. Tin oxide, indium oxide, and indium oxide in which tin is doped are preferable in particular.

The content of the cover layer in the carrier is preferably 5% by weight or more and more preferably from 5% by weight to 10% by weight.

The thickness of the cover layer is preferably from 0.1 μm to 5 μm and more preferably from 0.3 μm to 2 μm.

The thickness of the cover layer can be calculated as the average of the layer thickness obtained by observing 50 or more carrier cross sections using a transmission electron microscope (TEM) or scanning type transmission electron microscope (STEM) after making the carrier cross section by, for example, a focused ion beam (FIB).

There is no specific limit to formation of the cover layer of the carrier and any known method can be suitably used. For example, the cover layer of the carrier can be formed by coating the surface of the carrier core material with a cover layer solution in which raw materials for the cover layer such as a binder resin and a precursor thereof is dissolved by an air spraying method or a dip coating method. It is preferable to coat the surface of the core material with the cover layer solution (liquid cover) to form a carrier on which the cover layer is formed and heat the carrier to accelerate polymerization reaction of the binder resin or the precursor thereof. The heating treatment may be conducted in the coating device or by another separate heating device such as a typical electric furnace and a baking kiln, etc. after forming the cover layer.

Since the heating temperature depends on the materials for the cover layer, it is not possible to unambiguously determine the temperature. However, it is preferably from about 120° C. to about 350° C. and particularly preferably the decomposition temperature or lower of the materials for the cover layer The decomposition temperature of the materials for the cover layer is preferably up to about 220° C. and the heating time is preferably from about 5 minutes to about 120 minutes.

The carrier preferably has a volume average particle diameter of from 10 μm to 150 μm and more preferably from 40 μm to 100 μm. When the volume average particle diameter is too small, carrier attachment easily occurs due to the degradation of the uniformity of core material particles. In addition, when the volume average particle diameter is too large, reproducibility of fine portions of an image tends to be worsened, resulting in failure to production of images with a high definition.

The volume resistivity of the carrier is preferably from 9 [log(Ω·cm)] to 16 [log(Ω·cm)] and more preferably from 10 [log(Ω·cm)] to 14 [log(Ω·cm)]. When the volume resistivity is too low, carrier attachment tends to occur at non-image portions, which is not preferable. In addition, when the volume resistivity is too high, the image density at edge portions is emphasized in development, so-called edge effect, occurs. This is undesirable.

The volume resistivity can be adjusted by adjusting the thickness of the carrier cover layer and the content of the electroconductive particulates.

Image Forming Apparatus

The image forming apparatus that uses the toner of the present disclosure includes at least a latent electrostatic image bearing member (photoreceptor), a charger, an irradiator, a development device, a transfer device, and a fixing device with other optional devices.

The development device forms visible images by developing latent electrostatic images with toner.

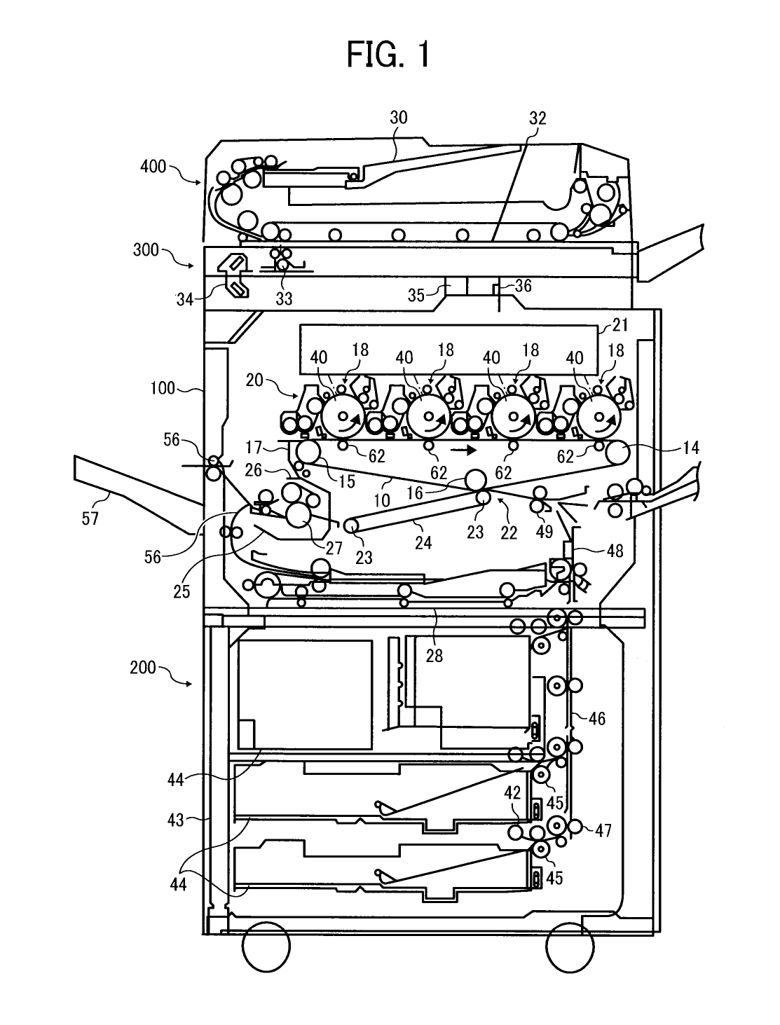

FIG. 1 is a schematic diagram illustrating an example of a two component development device using a two component development agent containing toner and magnetic carrier. This image forming apparatus includes a photocopying unit, a sheet feeder table 200, a scanner 300, and an automatic document feeder (ADF) 400.

The photocopying unit 100 has an intermediate transfer body 10 having an endless belt-like form at its center portion. An intermediate transfer body 10 is stretched around support rollers 14, 15, and 16 and rotatable clockwise in FIG. 1. An intermediate transfer cleaning device (cleaner) 17 is provided around the support roller 15 to remove the un-transferred residual toner on the intermediate transfer body 10. A tandem development device 20, which has four image forming units 18 for yellow, cyan, magenta, and black, is arranged facing the intermediate transfer body 10 stretched over the support rollers 14 and 15 along the transfer direction thereof. An irradiator 21 is arranged near the tandem development device 20. A secondary transfer device 22 is arranged facing the tandem development device 20 with the intermediate transfer body 10 therebetween. In the secondary transfer device 22, a secondary transfer belt 24, which is an endless belt, is stretched over a pair of rollers 23 and a recording medium transferred on the secondary transfer belt 24 is contactable with the intermediate transfer body 10 with each other. A fixing device 25 is arranged near the secondary transfer device 22.

In addition, in the image forming apparatus, a sheet reverse device 28 to form images on both sides of the recording medium by reversing the recording medium is arranged near the secondary transfer device 22 and a fixing device 25.

Next, the formation of a full color image using the tandem development device 20 is described.

First, a document (original) is set on a document table 30 on the automatic document feeder 400 or the automatic document feeder 400 is opened to set a document on a contact glass 32 for the scanner 300, and thereafter the automatic document feeder 400 is closed. When the start button is pressed, the scanner 300 is driven to scan the document on the contact glass 32 with a first scanning unit 33 and a second scanning unit 34 after the document is moved to the contact glass 400 in the case in which the document is set on the automatic document feeder 32 or immediately when the document is set on the contact glass 32. Then, the document is irradiated with light emitted from a light source by the first scanning unit 33 and the reflection light from the document is redirected at the mirror of the second scanning unit 34. The redirected light at the mirror of the second scanning unit 34 passes through an image focusing lens 35 and is received at a reading sensor 36 to read the document (color image), thereby obtaining black, yellow, magenta and cyan image data. Each image data for black, yellow, magenta, and cyan are transmitted to each image forming unit 18 (image forming units for black, yellow, magenta, and cyan) in the tandem development device 20 to form each color toner image of black, yellow, magenta, and cyan at each image forming unit.

As illustrated in FIG. 1, each image forming unit 18 in the tandem development device 20 includes a latent electrostatic image bearing member (photoreceptor) 40, a charger 60 to uniformly charge the latent electrostatic image bearing member 10, an irradiator to irradiate the latent electrostatic image bearing member 40 with beams of light according to each color image data to form a latent electrostatic image corresponding to each color image on the latent electrostatic image bearing member 40, a development unit 61 to form a toner image with each color toner by developing each latent electrostatic image with each color toner (black toner, yellow toner, magenta toner, and cyan toner), a primary transfer charger 62 to transfer the toner image to the intermediate transfer body 10, a cleaner 63, and a discharging device 64. Therefore, each single color image (black image, yellow image, magenta image, and cyan image) can be formed based on each color image data. The thus formed black color image, yellow color image, magenta color image, and cyan color image formed on the latent electrostatic image bearing members (photoreceptors) 40 are primarily and sequentially transferred to the intermediate transfer body 10 rotated by the support rollers 14, 15 and 16. Then, the black image, the yellow image, the magenta image, and the cyan image are superimposed on the intermediate transfer body 10 to form a synthesized color image (color transfer image).

In the sheet feeder table 200, one of the sheet feeder rollers 42 is selectively rotated to bring up recording media (sheets) from one of multiple sheet cassettes 44 stacked in a sheet bank 43. A separating roller 45 separates the recording media one by one to feed it to a sheet path 46. Transfer rollers 47 transfer and guide the recording medium to a sheet path 48 in the photocopying unit 100 of the image forming apparatus and the recording medium is held at a registration roller 49. The registration roller 49 is typically grounded but a bias can be applied thereto to remove paper dust on the recording medium. The registration roller 49 is rotated in synchronization with the synthesized color image (color transfer image) on the intermediate transfer body 10 to send the recording medium (sheet) between the intermediate transfer body 10 and the secondary transfer device 22. The synthesized color image (color transfer image) is secondarily transferred to the recording medium to form a synthesized color image thereon. The residual toner remaining on the intermediate transfer body 10 after image transfer is removed by a cleaner 17 for the intermediate transfer body.

The recording medium to which the color image is transferred is sent to the fixing device 25 by the secondary transfer device 22 and the synthesized color image (color transfer image) is fixed on the recording medium by heat and pressure at the fixing device 25. Thereafter, the recording medium is switched at a switching claw 55, discharged outside by a discharging roller 56, and stacked on a discharging tray 57. Alternatively, the recording medium is switched by the switching claw 55 and guided to the transfer position again by the sheet reverse device 28 to record another image on the reverse side of the recording medium. Thereafter, the recording medium is discharged by the discharging roller 56 and stacked on the discharging tray 57. Reference numerals 26 and 27 in FIG. 1 denote a fixing belt and a pressure roller, respectively.

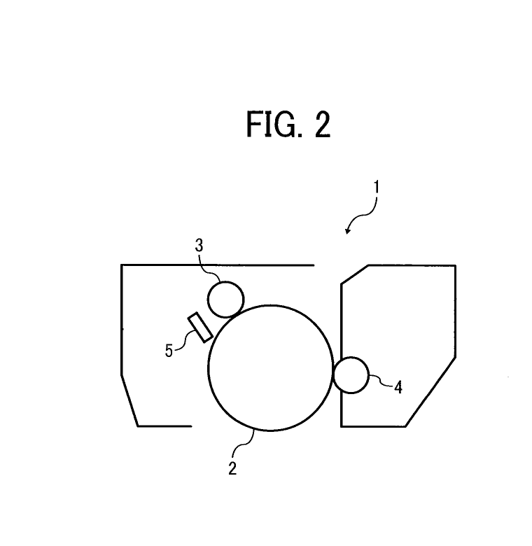

FIG. 2 is a schematic diagram illustrating an example of a process cartridge that uses the toner of the present disclosure.

A process cartridge 1 uses carrier and integrally includes at least a photoreceptor 2, a brush-like contact charger 3, a developing device 4 to accommodate the development agent of the present disclosure, and a cleaning blade 5 serving as a cleaner. The process cartridge 1 is detachably attachable to an image forming apparatus. In the present disclosure, the elements described above is integrally united in the process cartridge and is detachably attachable to an image forming apparatus such as a photocopier or a printer.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples and Comparative Examples but not limited thereto.

### Synthesis Example 1

### Synthesis of Block Copolymer A-1

212 g of L-lactide and 38 g of D-lactide (mass ratio of L-form to D-form=85/15) and 107 g of a crystalline polyester A2-1 of Synthesis Example 2 were placed in a separable flask followed by drying at 40° C. for 5 hours. Thereafter, the internal temperature was gradually raised to 150° C. After the system is confirmed to be uniform by naked eyes, 50 mg of tin 2-ethyl hexanoate was placed in the flask for polymerization reaction.

During this reaction, the internal temperature of the system was controlled not to surpass 190° C. After two-hour's reaction, the system was cooled down to 175° C. followed by de-lactide for 60 minutes under a condition of 10 mmHg to complete the polymerization reaction. A block copolymer A-1 was thus made. This resin has a weight average molecular weight (Mw) of 31,000 and a melting point of 51° C.

### Synthesis Example 2

### Crystalline Polyester A2-1

1,6-hexane diol and adipic acid were placed in a heated and dried flask equipped with a nitrogen introducing tube, a dehydration tube, a stirrer, and a thermoelectric couple with a ratio of OH/COOH of 1.15 to conduct reaction with 300 ppm of titan tetraisopropoxide at 200° C. to 230° C. for 10 hours at normal pressure followed by 5 hour reaction with a reduced pressure of 10 mmHg or less. A crystalline polyester A2-1 was thus obtained. The resin had a melting point of 55° C.

### Synthesis Example 3

### Synthesis of Crystalline Polyester B-1

1,6-hexane diol and a sebasic acid were placed in a heated and dried flask equipped with a nitrogen introducing tube, a dehydration tube, a stirrer, and a thermoelectric couple with a ratio of OH/COOH of 1.15 to conduct reaction with 300 ppm of titan tetraisopropoxide at 200° C. to 230° C. for 10 hours at normal pressure followed by 5 hour reaction with a reduced pressure of 10 mmHg or less. A crystalline polyester B-1 was thus obtained. This resin has a weight average molecular weight (Mw) of 22,000 and a melting point of 65° C.

Manufacturing procedures of toner of Examples and Comparative Examples are as follows:

Manufacturing Toner

Preparation of Master Batch 1

1,200 parts of water, 500 parts of carbon black (Printex 35, manufactured Degussa AG, DBP oil absorption amount: 42 ml/100 mg, PH: 9.5), and 1,500 parts of the block copolymer A are admixed by a Henschel Mixer (manufactured by NIPPON COKE & ENGINEERING. CO., LTD.). The mixture was kneaded at 120° C. for 30 minutes using two rolls and rolled and cooled down followed by pulverization by a pulverizer to obtain [Master Batch].

Preparation of Wax Liquid Dispersion

50 parts of a mixture of paraffin wax (HNP-9, hydrocarbon wax, melting point: 75° C., SP value 8.8, manufactured by Nippon Seiro Co., Ltd.) serving as a releasing agents and 450 parts of ethyl acetate were placed in a container equipped with a stirrer and a thermometer, While stirring the mixture, the system was heated to 80° C. After maintaining the temperature at 80° C., the system was cooled down to 30° C. in an hour. The resultant was subject to dispersion by a bead mill (ULTRAVISCOMILL, manufactured by AIMEX) under conditions of a liquid transfer speed of 1 kg/hour, a disk peripheral speed of 6 m/s, and a filling ratio of 0.5 mm zirconia beads of 80% by volume with three passes to obtain [Liquid Dispersion of Wax].

Preparation of Liquid Dispersion of Crystalline Polyester B

50 parts of the crystalline polyester B and 450 parts of ethyl acetate were placed in a container equipped with a stirrer and a thermometer and heated to 80° C. under stirring. After maintaining the temperature of 80° C. for 5 hours, the system was cooled down to 30° C. in an hour. The resultant was subject to dispersion by a bead mill (ULTRAVISCOMILL, manufactured by AIMEX) under conditions of a liquid transfer speed of 1 kg/hour, a disk peripheral speed of 6 m/s, and a filling ratio of 0.5 mm zirconia beads of 80% by volume with three passes to obtain [Liquid Dispersion of Crystalline Polyester B].

Preparation of Oil Phase

100 parts of [Master Batch], 500 parts of [Liquid Dispersion of Wax], 500 parts of [Liquid Dispersion of Crystalline Polyester B], and 700 parts of [Block Copolymer A] were placed in a container followed by mixing by a TK Homomixer (manufactured by Primix Corporation) at 5,000 rpm for 60 minutes to obtain [Oil Phase].

Preparation of Organic Particulate Emulsion (Liquid Dispersion of Particulate)

The following recipe was placed in a container equipped with a stirrer and a thermometer and stirred at 400 rpm for 15 minutes to obtain a white emulsion:
Water: 683 parts
Sodium salt of sulfate of an adduct of methacrylic acid with ethyleneoxide (EREMINOR RS-30, manufactured by Sanyo Chemical Industries, Ltd.): 11 parts
Styrene: 138 parts
Methacrylic acid: 138 parts
Ammonium persulfate: 1 part The system was heated until the temperature in the system was 75° C. to conduct reaction for 5 hours. Furthermore, 30 parts of 1% ammonium persulfate aqueous solution followed by aging at 75° C. for 5 hours to obtain an aqueous liquid dispersion of [Liquid Dispersion of Particulate] of a vinyl resin (copolymer of styrene, methacrylic acid, and a sodium salt of an adduct of a sulfate ester of methacrylic acid ethyleneoxide). The volume average particle diameter of [Liquid Dispersion of Particulate] measured by LA-920 (manufactured by Horiba, Ltd.) was 0.14 μm.

Preparation of Aqueous Phase

990 parts of deionized water, 83 parts of [Liquid Dispersion of Particulate], 37 parts of 48.5% by weight aqueous solution of sodium dodecyldiphenyl etherdisulfonate (EREMINOR MON-7, manufactured by Sanyo Chemical Industries, Ltd.), and 90 parts of ethyl acetate were mixed and stirred to obtain milk white liquid. This was determined as [Aqueous Phase].

Emulsification—Removal of Solvent

1,200 parts of [Aqueous Phase] was added to a container that accommodates [Oil Phase] followed by mixing by a TK HOMOMIXER at 13,000 rpm for 20 minutes to obtain [Emulsified Slurry].

[Emulsified Slurry] was placed in a container equipped with a stirrer and a thermometer followed by removal of the solvent at 30° C. for 8 hours. Subsequent to a 4 hour aging at 45° C., [Slurry Dispersion] was obtained.

Washing and Drying

After 100 parts of [Slurry Dispersion] was filtered with a reduced pressure, the following operations of 1 to 4 were repeated twice to obtain [Filtered Cake].
(1): 100 parts of deionized water was added to the filtered cake followed by mixed by a TK HOMOMIXER (at 12,000 rpm for 10 minutes);
(2): 100 parts of 10% sodium hydroxide was added to the filtered cake obtained in (1) and the resultant was mixed by a TK HOMOMIXER (at 12,000 rpm for 30 minutes) followed by filtration with a reduced pressure;
(3): 100 parts of 10% hydrochloric acid was added to the filtered cake obtained in (2) and the resultant was mixed by a TK HOMOMIXER (at 12,000 rpm for 10 minutes) followed by filtration; and
(4): 300 parts of deionized water was added to the filtered cake of (3) and the resultant was mixed by a TK HOMOMIXER (at 12,000 rpm for 10 minutes) followed by filtration.

The thus-obtained [Filtered Cake] was dried by a circulation drier at 45° C. for 48 hours.

The dried cake was screened using by a mesh having an opening of 75 μm to obtain [Toner].

### Example 1

Toner of Example 1 was obtained by using the block copolymer A-1 and the crystalline polyester B-1 in a mass ratio of 85% to 15% as a binder resin according to the method described above.

### Example 2

Toner of Example 2 was obtained by using the block copolymer A-1 and the crystalline polyester B-1 as a binder resin in a mass ratio of 95% to 5% according to the method described above.

### Comparative Example 1

Toner of Comparative Example 1 was obtained by using the block copolymer A-1 only as a binder resin according to the method described above.

### Comparative Example 2

Toner of Comparative Example 2 was obtained by using the block copolymer A-1 and the crystalline polyester B-1 in a mass ratio of 80% to 20% as a binder resin according to the method described above.

### Example 3

Block copolymer A-2 was obtained in the same manner as in Synthesis Example 1 except that the ratio of the crystalline polyester A2-1 was changed to 20%. This resin had a weight average molecular weight (Mw) of 29,000 and a melting point of 53° C.

Toner was obtained by using the block copolymer A-2 and the crystalline polyester B-1 in a ratio of 85% to 15% according to the method described above.

### Example 4

Block copolymer A-3 was obtained in the same manner as in Synthesis Example 1 except that the ratio of the crystalline polyester A2-1 was changed to 40%. This resin had a weight average molecular weight (Mw) of 34,000 and a melting point of 51° C.

Toner was obtained by using the block copolymer A-3 and the crystalline polyester B-1 in a mass ratio of 85% to 15% as a binder resin according to the method described above.

### Comparative Example 3

Block copolymer A-4 was obtained in the same manner as in Synthesis Example 1 except that the ratio of the crystalline polyester A2-1 was changed to 15%. This resin had a weight average molecular weight (Mw) of 29,000 and a melting point of 53° C.

Toner of Comparative Example 3 was obtained by using the block copolymer A-4 and the crystalline polyester B-1 in a mass ratio of 85% to 15% as a binder resin according to the method described above.

### Comparative Example 4

Block copolymer A-5 was obtained in the same manner as in Synthesis Example 1 except that the ratio of the crystalline polyester A2-1 was changed to 50%. This resin has a weight average molecular weight (Mw) of 29,000 and a melting point of 53° C.

Toner of Comparative Example 4 was obtained by using the block copolymer A-5 and the crystalline polyester B-1 in a mass ratio of 85% to 15% as a binder resin according to the method described above.

### Example 5

Block copolymer A2-2 was obtained in the same manner as in Synthesis Example 2 except that the acid component was changed to dodecanedioic acid. The resin had a melting point of 70° C.

Block copolymer A-6 was obtained in the same manner as in Synthesis Example 1 except that the crystalline polyester A2-1 was replaced with the crystalline polyester A2-2. This resin had a weight average molecular weight (Mw) of 29,000 and a melting point of 68° C.

Toner of Example 5 was obtained by using the block copolymer A-6 and the crystalline polyester B-1 in a mass ratio of 85% to 15% as a binder resin according to the method described above.

### Comparative Example 5

Block copolymer A2-3 was obtained in the same manner as in Synthesis Example 2 except that the ratio of OH/COOH was changed to 1.25. The resin had a melting point of 48° C.

Block copolymer A-7 was obtained in the same manner as in Synthesis Example 1 except that the crystalline polyester A2-1 was replaced with the crystalline polyester A2-3. This resin had a weight average molecular weight (Mw) of 33,000 and a melting point of 47° C.

Toner of Comparative Example 5 was obtained by using the block copolymer A-7 and the crystalline polyester B-1 in a mass ratio of 90% to 10% as a binder resin according to the method described above.

### Example 6

Crystalline polyester A2-4 was obtained in the same manner as in Synthesis Example 2 except that the alcohol component was changed to 1,3-propane diol and the acid component was changed to sebacic acid.

The resin had a melting point of 74° C.

Block copolymer A-8 was obtained in the same manner as in Synthesis Example 1 except that the crystalline polyester A2-1 was replaced with the crystalline polyester A2-4. This resin had a weight average molecular weight (Mw) of 28,000 and a melting point of 72° C.

Toner of Example 6 was obtained by using the block copolymer A-8 and the crystalline polyester B-1 in a mass ratio of 85% to 15% as a binder resin according to the method described above.

### Example 7

Block copolymer A-9 was obtained in the same manner as in Synthesis Example 1 except that the mass ratio L-lactide to D-Lactide was changed to 70/30. This resin had a weight average molecular weight (Mw) of 20,000 and a melting point of 53° C.

Toner of Example 7 was obtained by using the block copolymer A-9 and the crystalline polyester B-1 in a mass ratio of 85% to 15% as a binder resin according to the method described above.

### Comparative Example 6

Block copolymer A-10 was obtained in the same manner as in Synthesis Example 1 except that the mass ratio L-lactide to D-Lactide was changed to 100/0.

Toner of Comparative Example 6 was obtained by using the block copolymer A-10 and the crystalline polyester B-1 in a mass ratio of 85% to 15% as a binder resin according to the method described above.

### Example 8

Crystalline polyester A2-5 was obtained in the same manner as in Synthesis Example 2 except that the alcohol component was changed to 1,4-butane diol and the acid component was changed to sebacic acid.

The resin had a melting point of 62° C.,

Block copolymer A-11 was obtained in the same manner as in Synthesis Example 1 except that the crystalline polyester A2-1 was replaced with the crystalline polyester A2-5. This resin had a weight average molecular weight (Mw) of 25,000 and a melting point of 58° C.

Toner of Example 8 was obtained by using the block copolymer A-11 and the crystalline polyester B-1 in a mass ratio of 85% to 15% as a binder resin according to the method described above.

### Example 9

Crystalline polyester B-2 was obtained in the same manner as in Synthesis Example 3 except that the acid component was changed to dodecanedioic acid. This resin had a weight average molecular weight (Mw) of 23,000 and a melting point of 68° C.

Toner of Example 9 was obtained by using the block copolymer A-1 and the crystalline polyester B-2 in a mass ratio of 85% to 15% as a binder resin according to the method described above.

### Comparative Example 7

Toner of Comparative Example 7 was obtained by placing a solution in which the obtained crystalline polyester B-1 in Synthesis Example 3 was dissolved in ethyl acetate at 60° C. in the oil phase according to the method described above without dispersing the crystalline polyester B-1 obtained in Synthesis Example 3. The block copolymer A-1 and the crystalline polyester B-1 in a mass ratio of 85% to 15% was used as a binder resin.

### Comparative Example 8

When preparing the block copolymer of Synthesis Example 1, Resin A-12 was obtained according to Synthesis Example 1 without using the crystalline polyester A2-1 at all. This resin had a weight average molecular weight (Mw) of 28,000.

Toner of Comparative Example 8 was obtained by using the block copolymer A-12 and the crystalline polyester B-1 in a mass ratio of 85% to 15% as a binder resin according to the method described above.

### Example 10

Toner of Example 10 was obtained by using the block copolymer A-1 and the crystalline polyester B-1 in a mass ratio of 97% to 3% as a binder resin according to the method described above.

### Example 11

Block copolymer A2-6 was obtained in the same manner as in Synthesis Example 2 except that the ratio of OH/COOH was changed to 1.17. The resin had a melting point of 50° C.

Block copolymer A-13 was obtained in the same manner as in Synthesis Example 1 except that the crystalline polyester A2-1 was replaced with the crystalline polyester A2-6. This resin had a weight average molecular weight (Mw) of 29,000 and a melting point of 50° C.

Toner of Example 11 was obtained by using the block copolymer A-13 and the crystalline polyester B-1 in a mass ratio of 85% to 15% as a binder resin according to the method described above.

### Example 12

Block copolymer A-14 was obtained in the same manner as in Synthesis Example 1 except that the ratio of the crystalline polyester A2-1 was changed to 45%. This resin had a weight average molecular weight (Mw) of 29,000 and a melting point of 53° C.

Toner of Example 12 was obtained by using the block copolymer A-14 and the crystalline polyester B-1 in a mass ratio of 85% to 15% as a binder resin according to the method described above.

### Example 13

Block copolymer A-15 was obtained in the same manner as in Synthesis Example 1 except that the mass ratio L-lactide to D-Lactide was changed to 90/10. This resin had a weight average molecular weight (Mw) of 34,000 and a melting point of 51° C.

Toner of Example 13 was obtained by using the block copolymer A-15 and the crystalline polyester B-1 in a mass ratio of 85% to 15% as a binder resin according to the method described above.

### Synthesis Example 4

### Cryatalline Polyester (HD/AA)

1,6-hexane diol (HD) and adipic acid (AA) were placed in a heated and dried flask equipped with a nitrogen introducing tube, a dehydration tube, a stirrer, and a thermoelectric couple with a ratio of OH/COOH of 1.15 to conduct reaction with 300 ppm of titan tetraisopropoxide at 200° C. to 230° C. for 10 hours at normal pressure followed by 5 hour reaction with a reduced pressure of 10 mmHg or less. A crystalline polyester (HD/AA) was thus obtained. This resin had a weight average molecular weight (Mw) of 20,000 and a melting point of 55° C.

### Synthesis Example 5

### Crystalline Polyester (HD/DDDA)

1,6-hexane diol (HD) and dodecane diacid (DDDA) were placed in a heated and dried flask equipped with a nitrogen introducing tube, a dehydration tube, a stirrer, and a thermoelectric couple with a ratio of OH/COOH of 1.15 to conduct reaction with 300 ppm of titan tetraisopropoxide at 200° C. to 230° C. for 10 hours at normal pressure followed by 5 hour reaction with a reduced pressure of 10 mmHg or less. A crystalline polyester (HD/DDDA) was thus obtained. This resin had a weight average molecular weight (Mw) of 23,000 and a melting point of 68° C.

### Synthesis Example 6

### Crystalline Polyester (BD/SeA)

1,4-butane diol (BD) and sebacic acid (SeA) were placed in a heated and dried flask equipped with a nitrogen introducing tube, a dehydration tube, a stirrer, and a thermoelectric couple with a ratio of OH/COOH of 1.15 to conduct reaction with 300 ppm of titan tetraisopropoxide at 200° C. to 230° C. for 10 hours at normal pressure followed by 5 hour reaction with a reduced pressure of 10 mmHg or less. A crystalline polyester (BD/SeA) was thus obtained. This resin had a melting point of 62° C.

### Synthesis Example 7

### Crystalline Polyester (HD/SeA)

1,6-hexane diol (HD) and sebacic acid (SeA) were placed in a heated and dried flask equipped with a nitrogen introducing tube, a dehydration tube, a stirrer, and a thermoelectric couple with a ratio of OH/COOH of 1.15 to conduct reaction with 300 ppm of titan tetraisopropoxide at 200° C. to 230° C. for 10 hours at normal pressure followed by 5 hour reaction with a reduced pressure of 10 mmHg or less. A crystalline polyester (HD/SeA) was thus obtained. This resin had a weight average molecular weight (Mw) of 22.000 and a melting point of 65° C.

### Example 14

### Synthesis Example 8

### Synthesis of Block Copolymer A-16

848 g of L-lactide, 152 g of D-lactide, and 428 g of the crystalline polyester (HD/AA) were placed in a separable flask and dried at 40° C. for 5 hours. The internal temperature was gradually raised to 150° C. in a nitrogen stream. After confirming the system was uniform with naked eyes, 200 mg of tin 2-ethyl hexanoate was placed to conduct polymerization reaction. During this reaction, the internal temperature of the system was controlled not to surpass 190° C. After two-hour's reaction, the system was cooled down to 175° C. followed by de-lactide for 60 minutes under a condition of 10 mmHg to complete the polymerization reaction. A block copolymer was thus made.

Next, 1,300 g of the thus-obtained block copolymer was placed in the flask and the system was heated until the internal temperature reached 150° C. in a nitrogen stream to melt and uniformize the system. 5 g of 4,4′diphenyl methane diisocyanate was placed in the system to conduct reaction for an hour. Moreover, 5 g of carbodiimide compound (NCN, manufactured by Matsumoto Yushi-Seiyaku Co., Ltd.) was placed therein to conduct reaction for an hour to obtain a block copolymer A-16. This resin had a weight average molecular weight (Mw) of 31,000 and a melting point of 51° C.

Toner of Example 14 was obtained in the same manner as in Example 1 except that the block copolymer A-1 was changed to the block copolymer A-16, the crystalline polyester (HD/SeA) was used as the crystalline polyester B, and the content of the liquid dispersion of the crystalline polyester B for use in preparing the oil phase was changed to 750 parts.

### Example 15

### Synthesis Example 9

### Synthesis of Block Copolymer A-17

848 g of L-lactide, 152 g of D-lactide, 152 g of D-lactide, and 428 g of the crystalline polyester (HD/AA) were placed in a separable flask and dried at 40° C. for 5 hours. The internal temperature was gradually raised to 150° C. in a nitrogen stream. After confirming the system was uniform with naked eyes, 200 mg of tin 2-ethyl hexanoate was placed to conduct polymerization reaction. During this reaction, the internal temperature of the system was controlled not to surpass 190° C. After two-hour's reaction, the system was cooled down to 175° C. followed by de-lactide for 60 minutes under a condition of 10 mmHg to complete the polymerization reaction. A block copolymer A-17 was thus made. This resin had a weight average molecular weight (Mw) of 29,000 and a melting point of 53° C.

Toner of Example 15 was obtained in the same manner as in Example 14 except that the block copolymer A-1 was changed to the block copolymer A-17 and the content of the liquid dispersion of the crystalline polyester B for use in preparing the oil phase was changed to 250 g.

### Example 16

Crystalline polyester A-18 was obtained in the same manner as in Example 15 except that the content ratio of the crystalline polyester (HD/AA) was changed to 20% by weight. This resin had a weight average molecular weight (Mw) of 29,000 and a melting point of 53° C.

Toner of Example 16 was obtained in the same manner as in Example 14 except that the block copolymer A-16 was changed to the block copolymer A-18 and the content of the liquid dispersion of the crystalline polyester B for use in preparing the oil phase was changed to 500 g.

### Example 17

Crystalline polyester A-19 was obtained in the same manner as in Example 14 except that the content ratio of the crystalline polyester (HD/AA) was changed to 40% by weight. The content of carbodiimide compound was changed to 2.5 pHr. This resin had a weight average molecular weight (Mw) of 34,000 and a melting point of 51° C.

Toner of Example 17 was obtained in the same manner as in Example 16 except that the block copolymer A-18 was changed to the block copolymer A-19.

### Example 18

A block copolymer A-20 was synthsized in the same manner as in Example 17 except that the crystalline polyester was changed to HD/DDDA. This resin had a weight average molecular weight (Mw) of 29,000 and a melting point of 68° C.

Toner of Example 18 was obtained in the same manner as in Example 16 except that the block copolymer A-18 was changed to the block copolymer A-20.

### Example 19

Block copolymer A-21 was synthesized in the same manner as in Example 15 except that the mass ratio of L-lactide to D-Lactide was changed to 70/30. This resin had a weight average molecular weight (Mw) of 20,000 and a melting point of 53° C.

Toner of Example 19 was obtained in the same manner as in Example 16 except that the block copolymer A-18 was changed to the block copolymer A-21.

### Example 20

### Synthesis Example 10

### Synthesis of Block Copolymer A-22

765 g of L-lactide, 135 g of D-lactide, and 600 g of the crystalline polyester (BD/SeA) were placed in a separable flask and dried at 40° C. for 5 hours. The internal temperature was gradually raised to 150° C. in a nitrogen atmosphere. After confirming the system was uniform with naked eyes, 200 mg of tin 2-ethyl hexanoate was placed to conduct polymerization reaction. During this reaction, the internal temperature of the system was controlled not to surpass 190° C. After two-hour's reaction, the system was cooled down to 175° C. followed by de-lactide for 60 minutes under a condition of 10 mmHg to complete the polymerization reaction. A block copolymer was thus made.

Next, 1,300 g of the thus-obtained block copolymer was placed in the flask and the system was heated until the internal temperature reached 150° C. in a nitrogen atmosphere to melt and uniformize the system. 13 g of carbodiimide compound (NCN, manufactured by Matsumoto Yushi-Seiyaku Co., Ltd.) was placed in the system to conduct reaction for an hour to obtain a block copolymer A-22. This resin had a weight average molecular weight (Mw) of 25,000 and a melting point of 58° C.

Toner of Example 20 was obtained in the same manner as in Example 16 except that the block copolymer A-18 was changed to the block copolymer A-22.

### Example 21

Crystalline polyester A-23 was synthesized in the same manner as in Example 20 except that the crystalline polyester was changed to HD/AA. This resin had a weight average molecular weight (Mw) of 24,000 and a melting point of 52° C.

Toner of Example 21 was obtained in the same manner as in Example 14 except that the block copolymer A-16 was changed to the block copolymer A-23 and the crystalline polyester (HD/DDDA) was used as the crystalline polyester B.

### Example 22

Toner of Example 22 was obtained in the same manner as in Example 14 except that the block copolymer A-16 was changed to the block copolymer A-17 and the content of the liquid dispersion of the crystalline polyester B for use in preparing the oil phase was changed to 150 g.

### Example 23

Toner of Example 30 was obtained in the same manner as in Example 14 except that the block copolymer A-16 was changed to the block copolymer A-17.

### Example 24

Block copolymer A-24 was synthesized in the same manner as in Synthesis of Block Copolymer A-16 except that the content of MDI was changed to 0.5 phr and the content of carbodiimide compound was changed to 2.5 phr. This resin had a weight average molecular weight (Mw) of 34,000 and a melting point of 51° C.

Toner of Example 23 was obtained in the same manner as in Example 14 except that the block copolymer A-16 was changed to the block copolymer A-24.

Manufacturing of Development Agent

Manufacturing of Carrier

100 parts of silicone resin (organo straight silicone), 5 parts of γ-(2-aminoethyl)aminopropyl trimethoxy silane, and 10 parts of carbon black were added to 100 parts of toluene followed by dispersion for 20 minutes by a HOMOMIXER to prepare a resin layer liquid application. Using a fluid bed type coating device, the resin layer liquid application was applied to the surface of 1,000 parts of spherical magnetite having a volume average particle diameter of 50 μm to obtain carrier (toner carrier).

Manufacturing of Development Agent

5 parts of each Toner of Examples and 95 parts of the carrier were mixed by a ball mill to manufacture a development agent.

The properties of the toner of Examples and Comparative Examples and the materials for use therein. The results are shown in Tables 1 and 2.

Measuring of t130 and t′70

t130 and t′70 were measured by pulse NMR as follows:

Using Minispec-MQ20 (manufactured by Bruker Optics K.K.), attenuation curve was measured by pulse sequence (90°×−Pi−180° x) according to Hahn echo method under the following conditions:
Measuring nuclear: 1H
Resonance frequency: 19.65 MHz
Measuring gap: 5 s.

Pi: was 0.01 to 100 ms, the number of data points was 100, the cumulated number was 32, and the measuring temperature was changed from 50° C. to 130° C. to 70° C.

0.2 g of sample toner powder was put in a specialized sample tube, which was inserted to a suitable magnetic field. For each sample, the spin-spin relaxation time (t130) at 130° C. and (t′70) at 70° C. when descending from 130° C. to 70° C. were measured.

Measuring of Molecular Weight
Device: gel permeation chromatography (GPC, manufactured by TOSOH CORPORATION)
Detector: RI
Measuring temperature: 40° C.
Moving phase: Tetrahydrofuran
Amount of flow: 0.45 ml/min.

The number average molecular weight Mn, the weight average molecular weight Mw, and the molecular weight distribution Mw/Mn each were measured by gel permeation chromatography (GPC) using a standard curve prepared by the polystyrene sample whose molecular weight was already known.

Measuring of Melting Point

5.0 mg of the sample toner was placed in an aluminum sample container, the sample container was placed on a holder unit, and the container and the unit were set in an electric furnace. Thereafter, in the nitrogen atmosphere, the unit and the container were heated from 40° C. to 150° C. at a temperature rising speed of 10° C./min. Then, the system was cooled down from 150° C. to −60° C. at a temperature descending speed of 10° C./min. and again heated to 150° C. at a temperature rising speed of 10° C./min to measure a DSC curve using a difference scanning meter (Q-2000, manufactured by TA Instruments Inc.).

From the thus-obtained DSC curves, the DSC curve at the second time temperature rising was chosen using the analysis program installed in the system to obtain the maximum peak temperature (melting point) of the target sample from the peak tops.

Measuring of 90% RH Thermal Deformation Temperature
Device: TMA (EXSTAR 7000, manufactured by Hitachi High-Tech Science Corporation)

A die having a φ of 3 mm and a thickness of 1 mm was filled with 5 mg to 10 mg of a sample followed by compression by hand press to obtain a pill-form sample for measuring. Using the temperature/humidity control device mounted to the device, the temperature was raised from 30° C. to 90° C. at a temperature rising speed of 2° C./min. at 90% RH. Using a standard probe, the sample was pressed by a compression power of 100 mN to track the displacement thereof. After converting the obtained thermogram in the displacement amount %, the value at 50° C. was determined as the heat distortion temperature (TMA %) at 90% RH.

Agglomeration Resistance

After storing the toner at 50° C. for 8 hours, the toner was sieved by a screen of 42 mesh for 2 minutes to measure the remaining ratio on the metal mesh. The result was evaluated by the following criteria:

Evaluation Criteria
G (Good): the remaining ratio was less than 10%
F (Fair): the remaining ratio was from 10% to less than 20%
B (Bad): the remaining ratio was 20% or more

Low Temperature Fixability

Sheets (TYPE 6200 paper, manufactured by Ricoh Co., Ltd.) were set in a photocopier having a remodeled fixing device based on a photocopier (MF-200, manufactured by Ricoh Co., Ltd.) having a TEFLON™ roller in the fixing device to conduct a photocopying test. Specifically, while changing the fixing temperature, offset images were visually observed to obtain the cold-offset temperature (lower limit of fixing temperature) and the hot-offset temperature (upper limit of fixing temperature)

The evaluation conditions of the lowest fixing temperature were: linear speed of sheet feeding was from 120 mm/s to 150 mm/s, the surface pressure was 1.2 kgf/cm², and the nipping width was 3 mm.

The evaluation conditions of the highest fixing temperature were: linear speed of sheet feeding was 50 mm/s, the surface pressure was 2.0 kgf/cm², and the nipping width was 4.5 mm.

In addition, the range between the lowest fixing temperature (cold offset temperature) and the highest fixing temperature (hot offset temperature) was determined as the fixing temperature width.

The lowest fixing temperature is preferably 110° C. or lower and the fixing temperature width is preferably 40° C. or more.

TABLE 1

| | Example 1 | Example 2 | Example 3 | Example 4 | Example 5 | Example 6 |
|---|---|---|---|---|---|---|
| A | A-1 | A-1 | A-2 | A-3 | A-6 | A-8 |
| A2 | A2-1 | A2-1 | A2-1 | A2-1 | A2-2 | A2-4 |
| Content A2 | 30 | 30 | 20 | 40 | 30 | 30 |
| in A (% by | | | | | | |
| weight) | | | | | | |
| Melting point | 55 | 55 | 55 | 55 | 70 | 74 |
| (° C.) of A2 | | | | | | |
| Mass ratio of | 85/15 | 85/15 | 85/15 | 85/15 | 85/15 | 85/15 |
| L form to D- | | | | | | |
| form in A | | | | | | |
| B | B-1 | B-1 | B-1 | B-1 | B-1 | B-1 |
| [B/(A + B) × | 15 | 5 | 15 | 15 | 15 | 15 |
| 100 (% by | | | | | | |
| weight] | | | | | | |
| TMA % | 6.5 | 6 | 8 | 4.5 | 4.3 | 4.5 |
| Lowest fixing | 95 | 105 | 105 | 95 | 100 | 120 |
| temperature | | | | | | |
| (° C.) | | | | | | |
| Fixing | 45 | 55 | 50 | 50 | 50 | 50 |
| temperature | | | | | | |
| width (° C.) | | | | | | |
| Agglomeration | F | G | F | G | G | G |
| resistance | | | | | | |
| t130 (msec) | 34 | 35 | 24 | 45 | 43 | 40 |
| t′70 (msec) | 0.85 | 0.75 | 0.42 | 0.98 | 0.95 | 0.88 |
| | | | | Example | Example | Example |
| | Example 7 | Example 8 | Example 9 | 10 | 11 | 12 |
| A | A-9 | A-11 | A-1 | A-1 | A-13 | A-14 |
| A2 | A2-1 | A2-5 | A2-1 | A2-1 | A2-6 | A2-1 |
| Content A2 | 30 | 30 | 30 | 30 | 30 | 45 |
| in A (% by | | | | | | |
| weight) | | | | | | |
| Melting point | 55 | 62 | 55 | 55 | 50 | 55 |
| (° C.) of A2 | | | | | | |
| Mass ratio of | 70/30 | 85/15 | 85/15 | 85/15 | 85/15 | 85/15 |
| L form to D- | | | | | | |
| form in A | | | | | | |
| B | B-1 | B-1 | B-2 | B-1 | B-1 | B-1 |
| [B/(A + B) × | 15 | 15 | 15 | 3 | 15 | 15 |
| 100 (% by | | | | | | |
| weight] | | | | | | |
| TMA % | 7.5 | 7 | 4.2 | 7 | 10 | 5 |
| Lowest fixing | 100 | 100 | 105 | 110 | 95 | 95 |
| temperature | | | | | | |
| (° C.) | | | | | | |
| Fixing | 55 | 50 | 45 | 55 | 45 | 40 |
| temperature | | | | | | |
| width (° C.) | | | | | | |
| Agglomeration | F | F | G | G | G | G |
| resistance | | | | | | |
| t130 (msec) | 36 | 34 | 32 | 31 | 54 | 57 |
| t′70 (msec) | 0.86 | 0.84 | 0.92 | 0.63 | 0.95 | 0.99 |

| | Example | Comparative | Comparative | Comparative | Comparative |
|---|---|---|---|---|---|
| | 13 | Example 1 | Example 2 | Example 3 | Example 4 |
| A | A-15 | A-1 | A-1 | A-4 | A-5 |
| A2 | A2-1 | A2-1 | A2-1 | A2-1 | A2-1 |
| Content A2 | 30 | 30 | 30 | 15 | 50 |
| in A (% by | | | | | |
| weight) | | | | | |
| Melting point | 55 | 55 | 55 | 55 | 55 |
| (° C.) of A2 | | | | | |
| Mass ratio of | 90/10 | 85/15 | 85/15 | 85/15 | 85/15 |
| L form to D- | | | | | |
| form in A | | | | | |
| B | B-1 | — | B-1 | B-1 | B-1 |
| [B/(A + B) × | 15 | 0 | 20 | 15 | 15 |
| 100 (% by | | | | | |
| weight] | | | | | |
| TMA % | 4.5 | 5.5 | 15.5 | 11.5 | 5.5 |
| Lowest fixing | 95 | 125 | 95 | 120 | No |
| temperature | | | | | evaluation |
| (° C.) | | | | | |
| Fixing | 50 | 60 | 45 | 100 | No |
| temperature | | | | | evaluation |
| width (° C.) | | | | | |
| Agglomeration | G | G | B | B | G |
| resistance | | | | | |
| t130 (msec) | 37 | 7.4 | 42 | 8.2 | No |
| | | | | | evaluation |
| t′70 (msec) | 0.67 | 0.37 | 1.41 | 0.35 | No |
| | | | | | evaluation |

| | Comparative | Comparative | Comparative | Comparative |
|---|---|---|---|---|
| | Example 5 | Example 6 | Example 7 | Example 8 |
| A | A-7 | A-10 | A-1 | A-12 |
| A2 | A2-3 | A2-1 | A2-1 | — |
| Content A2 | 30 | 30 | 30 | — |
| in A (% by | | | | |
| weight) | | | | |
| Melting point | 48 | 55 | 55 | — |
| (° C.) of A2 | | | | |
| Mass ratio of | 85/15 | 100/0 | 85/15 | 85/15 |
| L form to D- | | | | |
| form in A | | | | |
| B | B-1 | B-1 | B-1 | B-1 |
| [B/(A + B) × | 10 | 15 | 15 | 15 |
| 100 (% by | | | | |
| weight] | | | | |
| TMA % | 25 | 0.5 | 12 | 20 |
| Lowest fixing | 95 | No | 125 | 115 |
| temperature | | evaluation | | |
| (° C.) | | | | |
| Fixing | 45 | No | 45 | 70 |
| temperature | | evaluation | | |
| width (° C.) | | | | |
| Agglomeration | B | G | B | B |
| resistance | | | | |
| t130 (msec) | 42 | No | 37 | 9.8 |
| | | evaluation | | |
| t′70 (msec) | 1.15 | No | 1.65 | 1.27 |
| | | evaluation | | |

TABLE 2

| | Example | Example | Example | Example | Example | Example |
|---|---|---|---|---|---|---|
| | 14 | 15 | 16 | 17 | 18 | 19 |
| Content (% by | 30 | 30 | 20 | 40 | 40 | 30 |
| weight) of | | | | | | |
| crystalline | | | | | | |
| polyester in A | | | | | | |
| Melting point | 55 | 55 | 55 | 55 | 70 | 55 |
| (° C.) of | | | | | | |
| crystalline | | | | | | |
| polyester in A | | | | | | |
| Polyester | HD/AA | HD/AA | HD/AA | HD/AA | HD/ | HD/AA |
| composition in | | | | | DDDA | |
| A) | | | | | | |
| Mass ratio of | 85/15 | 85/15 | 85/15 | 85/15 | 85/15 | 70/30 |
| L-form to D- | | | | | | |
| form in A | | | | | | |
| Addition | 0.5 | — | — | 2.5 | 2.5 | — |
| amount (phr) | | | | | | |
| of | | | | | | |
| carbodiimide | | | | | | |
| Addition | 0.5 | — | — | 0.5 | 0.5 | — |
| amount of | | | | | | |
| isocyanate | | | | | | |
| (phr) | | | | | | |
| [B/(A + B) × | 15 | 5 | 10 | 10 | 10 | 10 |
| 100 (% by | | | | | | |
| weight] | | | | | | |
| TMA % | 6.5 | 6 | 8 | 4.5 | 4.3 | 7.5 |
| Lowest fixing | 95 | 105 | 105 | 95 | 100 | 100 |
| temperature | | | | | | |
| (° C.) | | | | | | |
| Fixing | 45 | 55 | 50 | 50 | 50 | 55 |
| temperature | | | | | | |
| width (° C.) | | | | | | |
| Agglomeration | F | G | F | G | G | F |
| resistance | | | | | | |
| t130 (msec) | 34 | 35 | 24 | 45 | 43 | 36 |
| t′70 (msec) | 0.85 | 0.75 | 0.42 | 0.98 | 0.95 | 0.86 |

| | Example 20 | Example 21 | Example 22 | Example 23 | Example 24 |
|---|---|---|---|---|---|
| Content (% by | 40 | 40 | 30 | 30 | 40 |
| weight) of | | | | | |
| crystalline | | | | | |
| polyester in A | | | | | |
| Melting point | 62 | 55 | 55 | 50 | 55 |
| (° C.) of | | | | | |
| crystalline | | | | | |
| polyester in A | | | | | |
| Polyester | BD/SeA | HD/AA | HD/AA | HD/AA | HD/AA |
| composition in | | | | | |
| A) | | | | | |
| Mass ratio of | 85/15 | 85/15 | 85 | 85 | 90 |
| L-form to D- | | | | | |
| form in A | | | | | |
| Addition | 1 | 1 | — | — | 2.5 |
| amount (phr) | | | | | |
| of | | | | | |
| carbodiimide | | | | | |
| Addition | — | — | — | — | 0.5 |
| amount of | | | | | |
| isocyanate | | | | | |
| (phr) | | | | | |
| [B/(A + B) × | 10 | 15 | 3 | 15 | 15 |
| 100 (% by | | | | | |
| weight] | | | | | |
| TMA % | 7 | 4.2 | 7 | 10 | 4.5 |
| Lowest fixing | 100 | 105 | 110 | 95 | 95 |
| temperature | | | | | |
| (° C.) | | | | | |
| Fixing | 50 | 45 | 55 | 45 | 50 |
| temperature | | | | | |
| width (° C.) | | | | | |
| Agglomeration | F | G | G | G | G |
| resistance | | | | | |
| t130 (msec) | 45 | 46 | 28 | 54 | 44 |
| t′70 (msec) | 0.99 | 0.97 | 0.27 | 0.95 | 0.92 |

As shown in Tables 1 and 2, the toner of Examples 1 to 24 had a good combination of the low temperature fixing and the agglomeration resistance.

Toner of Comparative Example 1 had a good agglomeration resistance but the low temperature fixability thereof was not satisfactory.

Toner of Comparative Example 2 had an excellent low temperature fixability but the agglomeration resistance suffered.

With regard to toner of Comparative Example 3, both of the low temperature fixability and the agglomeration were not satisfactory.

Toner of Comparative Example 4 had an excellent agglomeration resistance but offset occurs all the area due to shortage of melt-viscosity, thereby failing to obtain satisfying fixability.

Toner of Comparative Example 5 had an excellent low temperature fixability but the agglomeration resistance suffered.

Toner of Comparative Example 6 had an excellent agglomeration resistance but offset occurs all the area at 170° C. or higher, thereby failing to obtain satisfying fixability.

With regard to toner of Comparative Example 7, both of the low temperature fixability and the agglomeration were not satisfactory.

With regard to toner of Comparative Example 8, both of the low temperature fixability and the agglomeration were not satisfactory.

The present invention provides toner having an excellent low temperature fixability and clumping resistance. That is, the toner simultaneously has good low temperature fixability and agglomeration resistance, which are trade-off, because it has agglomeration resistance until just before heat is applied for fixing and enables low temperature fixing by sharp softening when heat is applied.

In addition, by using the toner, quality images having excellent friction resistance are produced because the hardness of the images is improved by suppressing agglomeration of toner particles carrier contamination, and contamination in a development device ascribable to insufficient mechanical durability and degradation of chargeability and the fluidity caused by burial of external additives and in addition diminishing molecular movement of the toner immediately after fixing.

Having now fully described embodiments of the present invention, it will be apparent to one of ordinary skill in the art that many changes and modifications can be made thereto without departing from the spirit and scope of embodiments of the invention as set forth herein.

What is claimed is:

1. Toner comprising: a binder resin,
wherein the binder resin comprises a block copolymer A comprising a crystalline segment X and a non-crystalline segment Y,
wherein the toner has a thereto-mechanical analysis (TMA) compressive deformation amount (TMA %) of 10% or less at 50° C. and a relative humidity of 90%,
wherein the toner has a spin-spin relaxation time (t130) of 10 ms or greater at 130° C. as measured by pulse nuclear magnetic resonance (NMR),
wherein the toner has a spin-spin relaxation time (t′70) of 1 ms or less at 70° C. as measured by pulse NMR when descending from 130° C. to 70° C.

2. The toner according to claim 1, wherein the crystalline segment X has a polyester having a melting point of from 50° C. to 70° C. and is prepared by condensation of a polyol and a polycarboxylic acid.

3. The toner according to claim 1, wherein a mass ratio (X/Y) of the crystalline segment X to the non-crystalline segment Y is from 10/90 to 40/60.

4. The toner according to claim 1, wherein the binder resin further comprises a crystalline polyester B and a mass ratio of the block copolymer A and the crystalline polyester B satisfies a relation 1:
3≦[B/(A+B)]×100≦15 Relation 1.

5. The toner according to claim 1, wherein the block copolymer A comprises a unit formed of a crystalline polyester A2 accounting for 20% by weight to 45% by weight therein and having a melting point of from 50° C. to 70° C.

6. The toner according to claim 1, wherein the non-crystalline segment Y is a non-crystalline polylactic acid segment and a mass ratio of L form to D form of the polylactic acid segment in the block copolymer A is from 70/30 to 90/10.

7. The toner according to claim 1, wherein the block copolymer A comprises a portion formed of a carbodimide compound.

8. A development agent comprising:
carrier; and
the toner of claim 1.

9. An image forming apparatus comprising:
a latent electrostatic image bearing member to bear a latent electrostatic image thereon;
a charger to charge a surface of the latent electrostatic image bearing member;
an irradiator to irradiate a charged surface of the latent electrostatic image bearing member with light to form the latent electrostatic image thereon;
a development device to develop the latent electrostatic image with the toner of claim 1 to form a visible toner image;
a transfer device to transfer the visible toner image to a recording medium; and
a fixing device to fix the visible toner image transferred onto the recording medium.

10. An image forming method comprising:
charging an image bearing member;
irradiating a surface of the image bearing member to form a latent electrostatic image thereon;
developing the latent electrostatic image with the toner of claim 1 to obtain a visible toner image;
transferring the visible toner image to a recording medium;
fixing the visible toner image transferred to the recording medium; and
removing the toner of claim 1 remaining on the surface of the image bearing member.
